(19) United States
(12) Patent Application Publication
(10) Pub. No.: US 2005/0222929 A1
(43) Pub. Date: Oct. 6, 2005

(54) Systems and methods for investigation of financial reporting information

(75) Inventors: David Steier, Palo Alto, CA (US); Krishna Kumaraswamy, Mountain View, CA (US); Jimeng Sun, Pittsburgh, PA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: PricewaterhouseCoopers LLP

(21) Appl. No.: 11/022,180

(22) Filed: Dec. 21, 2004

Related U.S. Application Data
(63) Continuation-in-part of application No. 10/819,453, filed on Apr. 6, 2004.

(51) Int. Cl. G06F 17/60

(52) U.S. Cl. 705/35

(57) ABSTRACT

Financial data including general ledger activity and underlying journal entries are examined to determine whether risks of material misstatement due to fraudulent financial reporting can be identified. The financial data is analyzed statistically and modeled over time, comparing actual data values with predicted data values to identify anomalies in the financial data. The anomalous financial data is then analyzed using clustering algorithms to identify common characteristics of the various transactions underlying the anomalies. The common characteristics are then compared with characteristics derived from data known to derive from fraudulent activity, and the common characteristics are reported, along with a weight or probability that the anomaly associated with the common characteristic is an identification of risks of material misstatement due to fraud. Large volumes of financial data are therefore efficiently processed to accurately identify risks of material misstatement due to fraud in connection with financial audits, or for actual detection of fraud in connection with forensic and investigative accounting activities. The analysis is enhanced by using flow analysis methods to select subsets of financial data to examine for anomalies. Flow analysis methods are also used to reveal useful business information found in money flow graphs of financial data.

This application is a continuation-in-part of U.S. patent application Ser. No. 10/819,453, filed on Apr. 6, 2004, titled SYSTEMS AND METHODS FOR INVESTIGATION OF FINANCIAL REPORTING INFORMATION, and naming DAVID STEIER, KRISHNA KUMARASWAMY, and SHELDON LAUBE as inventors.

### FIELD OF THE INVENTION

The field of the invention relates to financial accounting and auditing, and more particularly to systems and methods of identifying risks of material misstatement due to fraudulent financial reporting in connection with a financial audit, and to systems and methods of investigating financial fraud with regard to forensic and investigative accounting.

### BACKGROUND OF THE INVENTION

Statement on Auditing Standards (SAS 99), issued by the American Institute of Certified Public Accountants (AICPA) in October, 2002, has had an impact on financial auditors in connection with identifying risks of material misstatement due to fraud. In this regard, auditors are now more likely to consider using fraud-oriented analytic and substantive tests, in particular, on journal entries and other adjustments to the books of an audit client.

Currently, auditors seeking to identify risks of material misstatement due to financial reporting fraud engage in time and resource-intensive searches and investigations of their audit client. For example, the auditor may manually review the financial reports of the client to identify suspicious data. The auditor may then interview employees of the client, and/or search selected client records, to determine the reasons for any anomalous data. This classic forensic investigation practice is often times costly and time consuming.

Also, financial and professional services firms perform forensic and investigative accounting, as part of specialized client engagements independent of financial audit engagements. Investigation and detection of financial fraud is often part of the focus of such engagements, and enhancements to the tools and methodologies currently available would be beneficial.

The role of information technology in today's accounting systems has lead to computer-assisted audit techniques (CAATs) for extraction and analysis of large volumes of data. This obviates or supplements some of the manual review of the audit client's accounting data in connection with an audit, or the investigative accounting client's accounting data in connection with a forensic accounting investigation. However, the effort required to apply such CAATs, especially for the extraction and normalization of large amounts of data, and to have auditors review the results of the CAATs, has also limited the applicability of such techniques. CAATs which rely upon a purely statistical analysis of a company's accounting data, to spot anomalous data, can extract and analyze a large amount of data. However, these CAATs report every anomalous data point, whether that data point is relevant to identification of risks of material misstatement due to fraud or not. This results in an over-reporting of anomalous data to the auditor, who must then investigate each and every anomaly using the classic forensic investigation practice discussed above. Similarly, conventional CAATs, as described above, also have limitations when used as tools in connection with forensic and investigative accounting activities, where efforts are made to investigate and detect fraud.

Conventional CAATs work at either of two levels, the financial statement level, or the underlying business transaction level. CAATs applied to the top-level financial statements, such as income statements, balance sheets, statements of stockholders' equity, statements of cash flows, etc., generally calculate simple ratios to be used in preliminary analytic review. For example they might calculate the days sales outstanding (“DSO”, which is the ratio of yearly net sales to receivables, divided by 365), because an increase in DSO may be indicative of premature revenue recognition, a form of financial statement fraud. While useful indicators of risk of material misstatement due to fraud, CAATs applied at the financial statement level are only preliminary indicators. These CAATs may report anomalies that may exist for a number of reasons besides risk of material misstatement due to fraud. Furthermore, these CAATs may be foiled by manipulation of the underlying accounts to preserve the top-level ratios in the financial statements.

At the finer-grained transaction level, conventional CAATs may perform simple reviews of the journal entries and general ledger activity that go into a typical accounting system. For example a common test is to screen for unusually large number of “round dollar amounts” ($5000 instead of $4893) appearing as sums of other numbers. These CAATs are also likely to flag entries that do not indicate risk of material misstatement due to fraud. Furthermore, the simple CAATs applied in practice are easily foiled by sophisticated perpetrators.

For certain types of fraud outside of the financial auditing and accounting fields, which do not require analysis of a large volume of data, it is possible to design a rule-based artificial intelligence (AI) system to analyze the data and look for patterns in the data. These sorts of AI systems are currently used to detect fraudulent usage patterns for credit cards and telephone billing. In these areas, the amount of data that needs to be examined is relatively small, and the number of rules that the AI system needs to apply is also relatively small. For example, to detect fraudulent use (or theft) of a credit card, the only data that need be examined is the charging patterns of a single credit card. The rules are likewise fairly simple, looking for things such as usage in foreign countries, high charging volume, usage in certain types of stores, etc. An example of an AI-based tool used to detect credit card fraud is discussed in US Published Patent Application No. U.S. 2002/0133721, which application is hereby incorporated herein by reference, in its entirety.

These rule-based systems, however, cannot scale up to handle the large volumes of data in a typical business entity's accounting system that need to be analyzed as part of a financial audit, in order to identify risks of material misstatement due to fraud. The rule-based systems cannot handle the typically millions of data points that need to be analyzed and correlated with each other. The human programmers required to maintain rule-based systems are generally not capable of managing a system that contains more than about 500-1000 rules. The programmers are unable to prune outmoded rules or add new rules fast enough to keep up with changes in accounting practices, nor are they able to modify and update the rules present in the system quickly enough. For example, as the business entity's business plan changes or the business entity merges with another business entity, or simply as the personnel in the business entity change, the parameters of the rule-based system would have to change to keep up with the changes in the business entity. The programmers are also unable to design a detailed enough rules system for such large data collections. Also, given that each business entity is different from one another, many of the rules cannot be used to analyze more than one business entity's data, thus necessitating a different set of rules to be created for each business entity that will be analyzed. Given that a public financial auditing firm may be responsible for auditing thousands if not tens of thousands of business entities in a year, rules-based systems quickly become unmanageable.

Therefore, in the financial audit context it would be useful to have a CAAT that identifies risks of material misstatement due to fraud, which is capable of analyzing large volumes of data, yet requires few enough resources such that the CAAT may be routinely applied to all audits conducted, not just to those audits where a high risk of material misstatement due to fraud has already been identified. Even knowledge of the mere existence of such risk screening tests, without any knowledge that the tests are being used on any particular business entity's accounting data, could act as a deterrent to those contemplating engaging in fraudulent acts. Similarly, it would be useful in the forensic and investigative accounting field to have a CAAT that is useful in investigating and detecting actual financial fraud while making efficient use of human and technical resources and tools in connection with such investigation.

### SUMMARY OF THE INVENTION

In an aspect of an embodiment of the invention, financial data is analyzed to identify anomalous data.

In another aspect of an embodiment of the invention, the anomalous data is analyzed to identify a characteristic of the anomaly.

In another aspect of an embodiment of the invention, the characteristic is compared with a characteristic of data from a second source, where fraud was present.

In another aspect of an embodiment of the invention relating to a financial audit, risks of material misstatement due to fraud are detected by drawing a correlation between the characteristic of the anomaly and a corresponding characteristic of the data from the second source, where fraud was present.

In another aspect of an embodiment of the invention, statistical analysis of financial data is combined with artificial intelligence analysis of the financial data.

In another aspect of an embodiment of the invention, journal entries are analyzed to identify anomalies.

In another aspect of an embodiment of the invention, general ledger activity is analyzed to identify anomalies.

In another aspect of an embodiment of the invention, clustering algorithms are used to extract common characteristics of groups of anomalous data items.

In another aspect of an embodiment of the invention, characteristics of transactions in accounts on dates where an anomaly has been identified are extracted by inducing decision trees to discriminate between such anomalous transactions and transactions in accounts and on days where no anomaly has been identified.

In another aspect of an embodiment of the invention, time-series data are created from general ledger balance information and journal entry information and analyzed to identify anomalies.

In another aspect of an embodiment of the invention, multivariate linear regression techniques are used to calculate predicted values for a time series, and the predicted values are compared to the actual values, to identify anomalies.

In another aspect of an embodiment of the invention relating to forensic or investigative accounting, a likelihood of financial reporting fraud is detected by correlating the characteristic of the anomaly and a corresponding characteristic of the data from the second source, where fraud was present.

In another aspect of an embodiment of the invention, money flows between financial accounts are analyzed to identify clusters of structurally related accounts.

In another aspect of an embodiment of the invention, a subset of accounts to be analyzed are selected, using a structural equivalence profile of a money flow graph of the accounts.

In another aspect of an embodiment of the invention, information derived from a structural equivalence analysis of money flows between financial accounts is used to make business decisions.

In another aspect of an embodiment of the invention, a money flow graph or flow matrix is used to generate an activity heat map that identifies clusters of accounts that are functionally similar.

In another aspect of an embodiment of the invention, the activity heat map clusters accounts based on the activity in the accounts, such as dollar volume of transactions, or number of transactions.

In another aspect of an embodiment of the invention, the principal components of a data set representing the transactions recorded in the general ledger are computed and analyzed to detect anomalies.

In another aspect of an embodiment of the invention, the principal components of a data set representing the transactions recorded in the accounts of a general ledger over a range of dates are applied based on the dates to identify patterns in clusters of dates that indicate risk of fraudulent manipulation.

In another aspect of an embodiment of the invention, the principal components of a data set representing the transactions recorded in the accounts of the general ledger is applied to the accounts to identify outliers that indicate accounts with risk of fraudulent manipulation.

In another aspect of an embodiment of the invention, principal component analysis is applied to pre-processed financial data, such as a daily activity matrix, to generate a set of principal components which are plotted against each other, to identify clusters of accounts that exhibit similar, and potentially anomalous, behavior.

### BRIEF DESCRIPTION OF THE DRAWINGS

In order to better appreciate how the above-recited and other advantages and objects of the present inventions are obtained, a more particular description of the invention briefly described above will be rendered by reference to specific embodiments thereof, which are illustrated in the accompanying drawings.

FIG. 1 depicts a receipt for a business transaction.

FIG. 2 depicts a partial listing of accounts for a business entity.

FIG. 3 depicts a partial listing of journal entries in the accounting system of a business entity.

FIG. 4A depicts a trial balance taken from the general ledger in the accounting system of a business entity.

FIG. 4B depicts a second trial balance taken from the general ledger in the accounting system of a business entity.

FIG. 5 depicts in a simplified form the relationship among various levels of details in the accounting system of a business entity.

FIG. 6 depicts a method of identifying risks of material misstatement due to fraud, according to an embodiment of the invention.

FIG. 7 depicts a graph used by a clustering algorithm to identify risks of material misstatement due to fraud, according to an embodiment of the invention.

FIG. 8 depicts a method of identifying such risks, according to an alternate embodiment of the invention.

FIG. 9 depicts a method of identifying such risks, according to another alternate embodiment of the invention.

FIG. 10 depicts a system for identifying such risks, according to an embodiment of the invention.

FIG. 11 depicts a method of analyzing money flows in financial accounts, according to an embodiment of the invention.

FIG. 12 depicts a simplified graph of representative accounts for a company.

FIG. 13 depicts the graph of FIG. 12 represented as an adjacency matrix.

FIG. 14 depicts a tree representation of a structural equivalence profile.

FIG. 15 depicts a method of creating an activity heat map of account activity, according to an embodiment of the invention.

FIG. 16 represents an unordered activity heat map.

FIG. 17 represents an ordered activity heat map, after application of a cross-association algorithm to the data of FIG. 16.

FIG. 18 represents an example of strongly correlated data in a graph.

FIG. 19 represents an example of uncorrelated data in a graph.

FIG. 20 represents a simple example of a graph of the first principal component against the second principal component for a data series.

FIG. 21 represents a more complex graph of the first principal component against the second principal component for a more complex data series of account activity for an account over a time period, showing fraud data and non-fraud data.

FIG. 22 depicts a graph of the first principal component against the second principal component for a data series of account activity over many accounts on a given day.

FIG. 23 depicts a portion of a Bayesian network of the factors that contribute to an example fraud scheme.

FIG. 24 depicts a method of performing a permutation testing analysis of financial data.

FIGS. 25A-B depict examples of original and permutated data sets where the original data sets are not from the same data distribution.

FIGS. 26A-B depict examples of original and permutated data sets where the original data sets are from the same data distribution.

### DETAILED DESCRIPTION OF THE PREFERRED EMBODIMENTS

The bookkeeping operations of a business entity or other enterprise revolve around the recording process, where the evidence of business transactions is recorded in a form that can ultimately be summarized and used by management, investors, regulators, shareholders, auditors, etc. When a business transaction occurs, some sort of evidence of the transaction is recorded. This may be a receipt, a purchase order, an e-mail, a cancelled check, a wire transfer record, or any other form of recording evidence of business transactions. The business transaction may be a transaction with an external entity, such as a supplier, vendor or customer, or it may be an internal transaction or adjustment, for example to ensure that revenue and expenses are recognized in the period they actually occurred, or to reflect a change in accounting practices, re-organization of a company's accounts, or for any other reason why a company may need to make internal transactions or adjustments to its books.

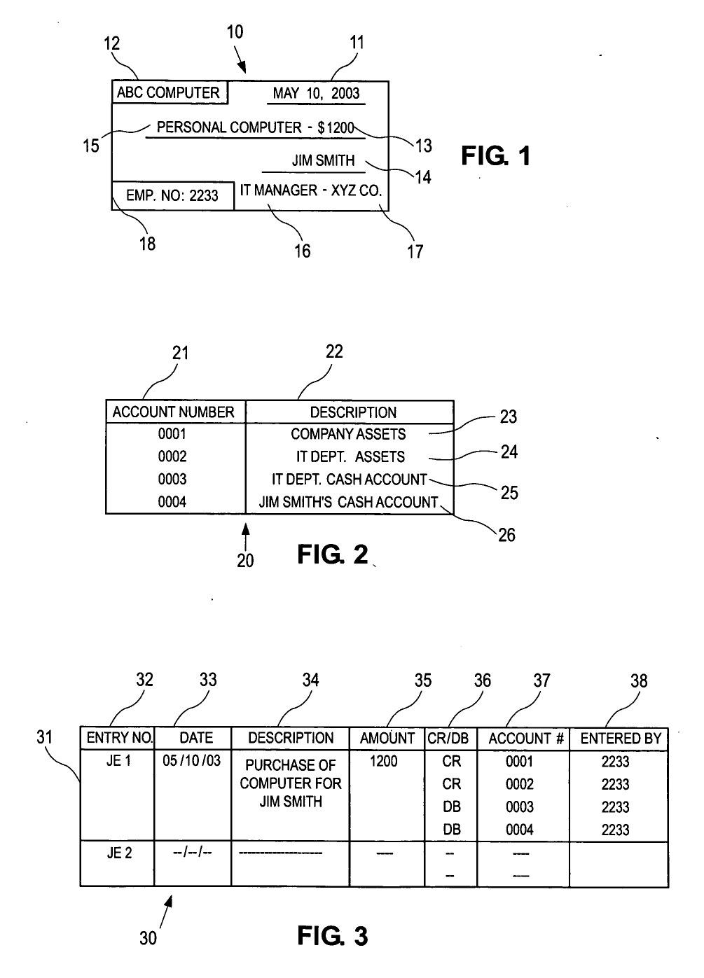

An example transaction for a simplified accounting system is shown in FIG. 1. Computerized accounting systems used in practice often employ more complex methods of tracking transactions and accounts, such as using sub-ledgers, using additional fields associated with each transaction, using other ways of classifying transactions, etc. The methods of embodiments of the invention are also applicable to these more complex accounting systems. FIG. 1 shows a receipt 10 for the purchase of a computer. The receipt 10 includes information identifying the transaction date 11, the vendor 12, the transaction amount 13, the purchaser 14, the purchased item 15, the purchaser's position or title 16 within the business entity, the name 17 of the business entity, and the employee number 18 of the person who entered the transaction into the accounting system. This receipt shows that the computer was purchased on May 10, 2003, by Jim Smith, the IT Manager for XYZ Co., from ABC Computer, Inc. The transaction was recorded by an employee with the employee number “2233”. This transaction is received by the accounting department of XYZ Co., and it is analyzed by the accounting department staff to determine the impact this transaction will have on the accounts of the business entity.

A business entity may keep separate accounts for all of the various categorizations the business entity wishes to break out and record its financial data. For example, turning to FIG. 2, a partial listing of sample accounts for XYZ Co. is shown. The account list 20 includes account numbers 21 and account descriptions 22. The account numbers 21 are used by the business entity to easily identify and track the accounts used to record the business transactions. The account descriptions 22 are used to assist human users of the business entity's accounting system in understanding what purpose each account serves. The account list 20 includes four accounts. First is the Company Assets account 23. This account tracks all assets that the business entity acquires or sells, as well as manages depreciation (loss in value over time) of these assets. Second is the Information Technology (IT) Department's asset account 24. This account serves a similar purpose to the Company Assets account 23, but it only tracks assets attributable to the IT department. Third is the IT Department Cash account 25. This account serves to keep track of the amount of money the IT department has available to spend. Every time the IT department spends money, the amount the department spends is credited from the IT Department Cash account 25. Likewise, every time the business entity decides to fund the IT department, the IT Department Cash account 25 is debited with an additional amount. Last is Jim Smith's Personal Cash account 26. This account serves a similar purpose to the IT Department Cash account 25, but it only tracks the amount of money available for Jim Smith to spend. The example accounts discussed above for the example company XYZ Co. are presented to aid the discussion of embodiments of the invention. There are a wide variety of different ways a company could choose to organize its accounting system. The particular details of how a company organizes its accounting system are design choices and are not critical to the disclosed embodiments of the invention.

When a business transaction occurs, it is analyzed to determine its debit and credit effect on specific accounts of the business entity, and is recorded in chronological form in a journal. The content of journal entries varies from business entity to business entity, but will typically contain at least the date of the transaction, the accounts to be debited and credited, and an explanation of the transaction. There may be additional data recorded, such as the time of day of the transaction, the identity of the person who made the transaction, the identity of the person who recorded the transaction into the journal, the location where the transaction was entered into the journal, etc.

When the receipt 10 (of FIG. 1) is received by the accounting department of XYZ Co., the receipt is processed by the accounting staff, and a journal entry for the transaction is entered into the journal for XYZ Co. Turning to FIG. 3, a journal 30 showing the journal entry 31 for the transaction 10 is shown. The journal entry includes an identifier 32, a transaction date 33, a transaction description 34, an amount 35, a credit/debit indicator 36, an account 37 against which to apply the journal entry 31, and a user ID field 38 that identifies who entered the data into the journal. Depending on the specifics of the accounting system, the accounting staff may enter a separate journal entry 31 for each account to be credited/debited, or alternatively there may be a single journal entry 31 for the transaction, recording all of the accounts to be credited/debited. Depending on the specifics of the accounting system, other information may be stored in the journal 30, such as the name of the person involved in the transaction, the name of the person entering the journal entry, or any of the other information discussed above.

The accounting staff examines the receipt 10, and notes that it is for the purchase of a computer, which has become an asset of the company. Therefore, the accounting staff logs a debit to the Company Assets account 23 in the amount of $1200, the value of the computer. Similarly, the accounting staff notes that the computer was purchased for the IT department, and logs a debit to the IT Department Assets account 24. Since the computer was purchased for the IT department, this expense must come out of the IT department's cash account. Therefore, the accounting staff logs a credit from the IT Department Cash account 25. Similarly, since the computer is for Jim Smith's use, the accounting staff logs a credit from Jim Smith's Personal Cash account 26. The accounting staff processes every business transaction of the business entity in a similar manner, by entering journal entries for every external and internal transaction, crediting and debiting the accounts of the business entity as needed to reflect the impact of each transaction on the books of the business entity.

The sum total of these journal entries are periodically posted to the business entity's accounts, where the account activity in each account is adjusted. This account activity is accumulated in a general ledger, which shows the activity of every account in the business entity. The general ledger is an aggregation of the journal entries, sorted by account. Since the business entity is constantly receiving and recording business transactions into the journal and the journal entries are periodically posted to the accounts in the general ledger, the general ledger activity changes over time. When someone is interested in viewing the general ledger information, the person will extract a trial balance from the general ledger, which lists the accounts and their activity at a particular point in time.

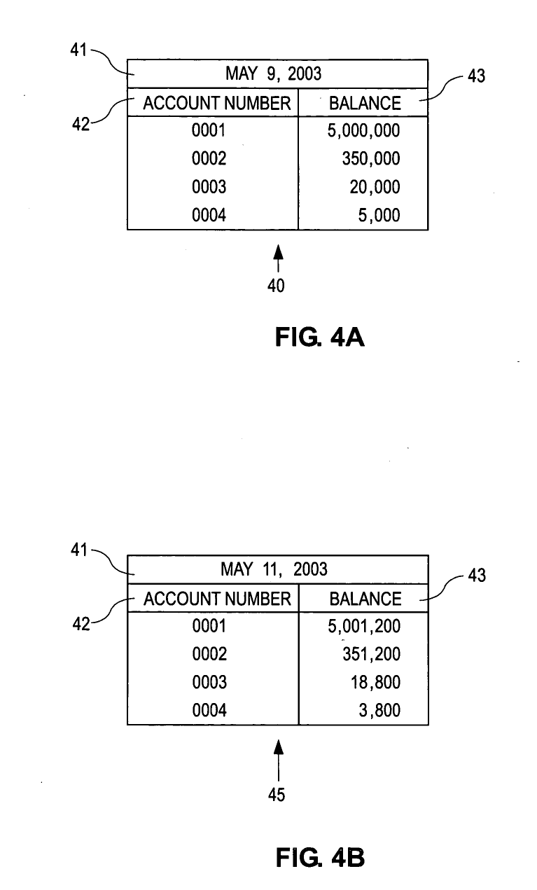

Turning to FIG. 4A-4B, two trial balances for the general ledger of XYZ Company are shown. FIG. 4A shows a trial balance 40 taken prior to the posting of the transaction 10 to the business entity's accounts, and FIG. 4B shows a trial balance 45 taken after the transaction 10 has been posted to the business entity's accounts. Turning to FIG. 4A, the trial balance 40 reflects a balance in the Company Assets account 23 (acct. # 0001) of $5,000,000. The trial balance reflects a balance in the IT Department Assets account 24 (acct. # 0002) of $350,000. Similarly, the IT Department Cash account 25 has a balance of $20,000, and Jim Smith's Personal Cash account 26 has a balance of $5,000. Turning to FIG. 4B, the trial balance 45, taken after the journal entry 31 has been posted to the accounts, shows a higher balance of $5,001,200 in the Company Assets account 23, to reflect the increase in the company's total assets caused by the purchase of the computer. Similarly, the IT Department Assets account 24 has increased by $1,200, reflecting the purchase of the computer. The IT Department Cash account 25 has been reduced by $1,200, to reflect the purchase of the computer using IT department funds. Similarly, Jim Smith's Personal Cash account 26 has been reduced by $1,200, reflecting that the computer purchase came out of his personal portion of the IT department funds. Trial balances such as these may generally be taken at any time, and function as a snapshot of the activity in the general ledger and therefore of the company's financial position.

When these trial balances have been updated to reflect any pertinent adjustments, such as depreciation of assets, or accruals (revenues earned but not yet received or recorded, and expenses incurred but not yet paid or recorded), they can then be used to prepare financial statements, which are consolidated reports of activity across many accounts. For example, financial statements may include income statements, balance sheets, statements of stockholders' equity, statements of cash flows, etc. It is these financial statements that are typically made available to investors, regulators, and, for publicly held entities, the general public.

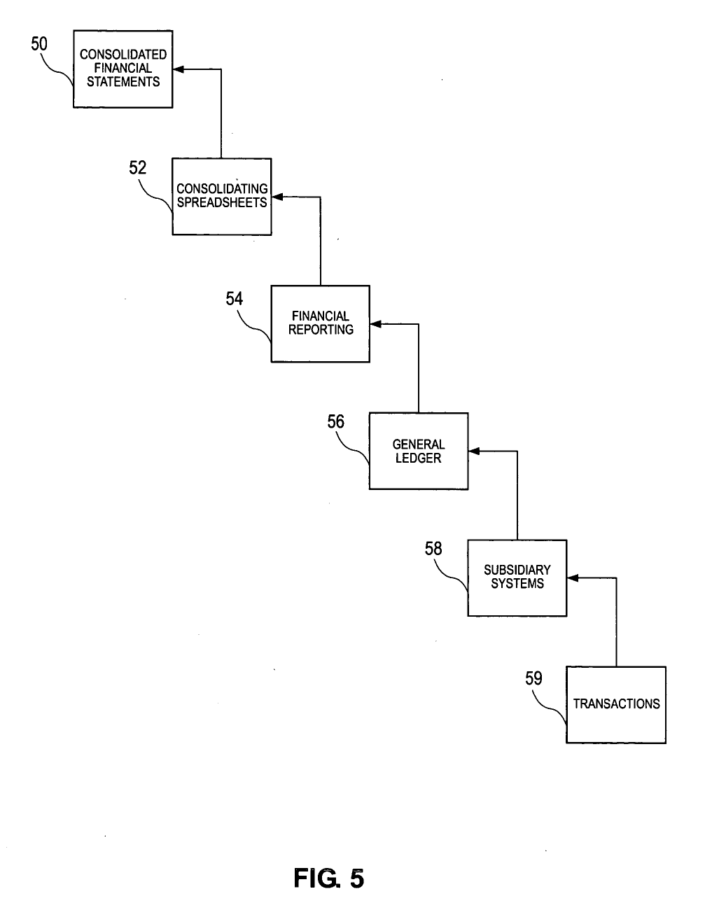

In summary, turning to FIG. 5, the roll-up mapping of a typical financial system implemented in a large company includes at the highest level the consolidated financial statements 50. These consolidated financial statements 50 can be broken down into the various reporting entities that comprise the consolidated totals reported on the consolidated financial statements 50. For example, a large company may have many reporting entities, such as divisions or subsidiaries, each of which maintains separate accounting systems, and reports financial information up to the consolidated financial statements 50.

The entries in the consolidated financial statements 50 can be generated from the financial statements for each reporting entity via various different methods. One such method through use of consolidating spreadsheets 52, which gather together corresponding entries from the financial statements and tabulate the consolidated entries for the consolidated financial statements 50. Alternatively, the company may use any of a variety of software applications which automate this process.

The financial statements for each reporting entity are generated by consolidating the activity in the various accounts maintained by the entity's accounting system, and rolling up that consolidated activity to the various line items of the financial statements, using financial reporting 54. For example, a cash line item of a financial statement may include the activity from several accounts, such as Petty Cash, Checking, Payroll, etc., all of which are rolled up to the cash line item via financial reporting 54.

Account activity is tracked in the general ledger 56, which is composed of postings from various subsidiary systems 58. For example, the subsidiary systems 58 may include systems which account for Revenue/Receivables, Purchases/Payables, Payroll, Fixed Assets, Inventory, and General Journal entries. The subsidiary systems 58 receive transactions 59, which are the lowest level data entered by the accounting staff. The journal entries discussed above are examples of these transactions 59.

Therefore, a consolidated financial statement 50 is a consolidated report of activity that can be traced down to activity in the general ledger 56, and also down to the journal entries or transactions 58 in the journal that affect the activity in the general ledger 56. Since the information reported in the consolidated financial statements 50 is relatively easily traceable back to the information contained in the general ledger 56 and journal entries or transactions 58, someone wishing to falsify information on a consolidated financial statement 50, or otherwise make material misstatements, and make that false information difficult for conventional CAATs to identify, will also typically create falsified entries in the company's general ledger 56 and falsified journal entries 57.

Note that if a perpetrator merely alters two financial statement entries and causes them to balance one another out, without “grounding” the altered financial statement entries in the business entity's general ledger and journal, then there would be a discrepancy between the amount reported on the financial statement and the sum of the underlying ledger activity that went into the financial statement value. This discrepancy would be relatively easy for conventional CAATs to detect.

For example, the “Corporate Assets” line reported on a financial statement is an aggregate sum of many different accounts in the general ledger (i.e. divisional asset accounts, tangible assets, intangible assets, etc). If a perpetrator wanted to increase the value of the assets of the business entity, he could simply alter the “Corporate Assets” line on the financial statement, and make a corresponding alteration in the “Corporate Liabilities” line of the financial statement, (or more likely the “Shareholder Equity” line), such that the assets and liabilities remained in balance. However, such actions could be detected, merely by comparing the “Corporate Assets” line on the financial statement against the sum of all of the various general ledger account activity which was used to derive the aggregate “Corporate Assets” number. Similarly, if the perpetrator altered the general ledger activity without providing corresponding journal entries, then such actions could be detected by merely comparing the general ledger balance for each account with the sum of the journal entries that affect that account. To avoid being easily detected, the perpetrator must fabricate financial data all the way down to the journal entry level.

To identify risks of material misstatement due to fraud, a financial auditor will inspect the financial statement 50 for evidence of such risks, such as to determine whether the company's assets and liabilities match, or to determine if the financial statement 50 correctly report the information contained in the general ledger 57. Only the most simplistic wrongful activities, however, will be discoverable by reviewing financial statements alone. Sophisticated perpetrators have learned how to create financial statements that appear normal, yet conceal evidence of their wrongful acts; for example by grounding the wrongful activity with falsified journal entries, as discussed above. To identify risks of material misstatement due to sophisticated frauds, a financial auditor may drill down into the underlying general ledger information and journal entries, to review these entries for signs of such risks.

Even in cases of sophisticated frauds being perpetrated, with any alterations of the financial statement activity being grounded with falsified journal entries as discussed above, the flows of data through the accounts of a business entity are such that risks of material misstatement due to fraudulent manipulation of the underlying ledger and journal data may be able to be detected, provided sufficient time and resources are used. When a perpetrator makes changes in one or a few activities in an otherwise normal general ledger, these changes will have implications for the other activities. For example, an increase in sales for a business entity implies a corresponding increase in the cost of generating those sales, which is often due to an increase in labor costs, which is correlated with an increase in spending on workers' compensation insurance, and so forth. Similarly, an increase in sales should show a corresponding increase in assets, as the business entity purchases more equipment to handle the additional business. Thus, a perpetrator who wished to falsify the sales figures for a business entity in order to show increased revenue, would likely also have to falsify the figures for the business entity's cost of sales, labor costs, workers' compensation insurance, and a host of other figures. In many instances, these falsified figures would have to be grounded with falsified journal entries. The general ledger of a typical business entity contains so many accounts and records the effects of so many transactions, that it would be difficult for a perpetrator to make significant alterations and still preserve all of the interrelationships between and among the various accounts, as they would exist in normal, non-fraudulent operations.

Therefore, a method that identifies risks of material misstatement due to fraud that examines the journal entries and general ledger account activity underlying a financial statement, in order to detect disruptions of the interrelationships between or among the accounts, should be capable of identifying many such risks which conventional auditing techniques would miss. As noted above, however, conventional CAATs do not attempt to model these interrelationships, in part because they do not allow for the accurate and efficient processing of the volumes of data necessary to be evaluated in order to identify these risks. The CAATs that can process large volumes of data are incapable of accurately identifying such risks, and the CAATs that are capable of accurately identifying such risks are incapable of processing the large volumes of data found in most accounting systems.

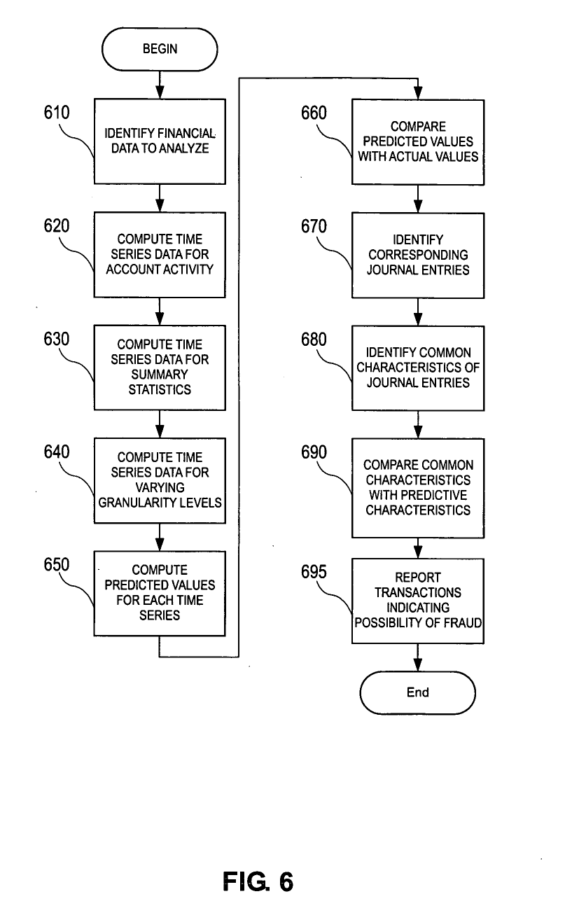

In an embodiment of the invention shown in FIG. 6, a method for identifying risks of material misstatement due to fraud avoids these and other drawbacks to conventional CAATs. The method of FIG. 6 combines statistical analysis techniques with artificial intelligence techniques, in order to identify anomalous data, then identify the reasons why the data is anomalous, and finally to determine if the reasons for the anomaly suggest risks of material misstatement due to fraud. This method may be implemented as a CAAT, in computer software or hardware or a combination of the two.

The method begins at step 610, where the collection of financial data to work on is identified. For example, the CAAT is used on the general ledger account activity and the journal entries from XYZ Company, which is being audited by an auditor using the CAAT. At step 620, using the financial data of XYZ Company, a collection of time series data based on the account activity in the general ledger, gathered over time, is computed. For example, a trial balance is computed for each account in the general ledger, over a series of time intervals, such as daily, weekly, monthly, quarterly, or annually. Additional time series data may be computed for dates of particular interest, including non-continuous dates such as the last day of a reporting period, such as the end of each month, quarter, or year. These time series are used to analyze trends that might otherwise be masked by the data from the rest of the time interval, but when examined in isolation could reveal trends indicative of the presence of risks of material misstatement due to fraud.

At step 630, further time series data is gathered based on other factors, such as various summary statistics for the activity, and the incremental changes to the activity over various time periods, reflected in the general ledger for the same time periods. For example, a monthly time series is generated for the mean balance for each month for each account, over the time period being measured. Time series are also generated for the changes to the balance over each day, week, month, quarter, and year. Similarly, a monthly time series is generated for other statistics, such as the variance among activity values, the minimum and maximum activity values, the skewness of the distribution of the activity for the month, and/or the kurtosis of the distribution of the activity for the month. (Skewness is a measure of the asymmetry of a data distribution—the closer the distribution is to the distribution in a symmetric bell-curve, the closer the skewness is to 0. Kurtosis is a measure of how “peaked” the data distribution, “spikes” have higher kurtosis than “plateaus”.) If desired, additional time series data which computes non-linear time series data, such as the square or the cube of the account value, may be computed if it is determined that an analysis of such data may be useful to detect the risks of material misstatement due to fraud. At step 640, additional time series data for the account activity and for the summary statistics on the transaction data are generated, at varying levels of granularity (e.g. yearly, quarterly, monthly, weekly, and/or daily.). Additional time series may be created based on the pairwise correlation among the account activity.

At step 650, the time series data gathered in steps 620-640 is then used to calculate a predicted value for each time series at each point in time, as a function of the past actual values in the time series as well as all of the past and present values of the other account activity at all points in time. These predicted values can be created using a well-known statistical technique known as multivariate linear regression. To briefly summarize this technique, multivariate linear regression is a technique for predicting the present value of a time series of data (such as the monthly account activity and other data collected from the financial data for XYZ Company as discussed at step 620-640 above), using the past values from the same time series, and the past and present values of the other time series. For example, the present value of the company assets account 23 is predicted by computing the past values of the company assets account 23, computing the past and present values for the other accounts 24-26 of XYZ Company, as well as the past and present values of the other time series discussed above, such as the summary statistics. These computed values are each modified by a regression coefficient, which measures the relative contribution of each computed value to the predicted value. Mathematically, the predicted value can be expressed as linear combination of the past values of the target time series and the past and present values of all of the other time series. The equation is as follows, for a time series S₁, at time t:

$${s}_{1} ( t ) = {a}_{1 , 0} {s}_{1} [ t - 1 ] + … + {a}_{1 , w} {s}_{1} [ t - w ] + {a}_{2 , 0} {s}_{2} [ t ] + {a}_{2 , 1} {s}_{2} [ t - 1 ] + … + {a}_{2 , w} {s}_{2} [ t - w ] + {…a}_{k , 0} {s}_{k} [ t ] + {a}_{k , 1} {s}_{k} [ t - 1 ] + … + {a}_{k , w} {s}_{k} [ t - w ]$$

$$for all t = w + 1 , … , N .$$

The values a_{i,j} (i=1 . . . k; j=0 . . . w) are the regression coefficients for each computed value. The equation may be solved for the regression coefficients using a variety of techniques, such as by using a commercial software package such as SPSS, available from SPSS Inc of Chicago, Ill. Further discussion of multivariate linear regression techniques may be found in B.-K. Yi, N. D. Sidiropoulos, T. Johnson, A. Biliris, H. V. Jagadish and C. Faloutsos, Online Data Mining for Co-Evolving Time Sequences, In Proceedings of the IEEE Sixteenth International Conference on Data Engineering, pages 13-22 (2000), which reference is hereby incorporated herein by reference, in its entirety.

Once each predicted value is computed for each time series at each point in time, then these predicted values are compared to the actual values for each of those time series at each time, at step 660, to identify instances where the actual and predicted values are different. For example, if the predicted value for the Company Assets account 23 for June, 2003 is $5,250,000 but the actual value for the Company Assets account 23 for June, 2003 is $5,100,000, this actual value is flagged as being different from the predicted value. Depending on how many data points the auditor or CAAT wishes to examine, a subset of the data points which differ may be identified instead. For example, the auditor may determine that only the top N cases where the predicted values and the corresponding actual values differed the most are significant enough to be examined. These identified values represent anomalies significant enough to be further investigated. A further indication of an anomalous data point is obtained by comparing the coefficients or correlations as discussed above as calculated: if the coefficients or correlations change significantly at some point in time, this may indicate a risk of manipulation of the underlying data. Comparison of the coefficients or correlations as well as the values predicted by the model against the actual value may be done for any or all of the summary distribution statistics discussed above, as well as for the account activity itself.

Once the anomalous account values (and optionally the anomalous summary statistics or other values examined using the statistical techniques discussed above) have been identified, then at step 670 the journal entries which correspond to the anomalous account balance values (or other values of interest) are identified. For example, the actual closing balance for June, 2003 for the Company Assets account 23 was identified as being anomalous, based on the predicted value for that actual value of that account as computed using the statistical analysis discussed above. Therefore, all of the journal entries for June, 2003 which credited or debited the Company Assets account 23 are then identified for further examination. This examination seeks to identify the reasons why the actual value was different from the predicted value.

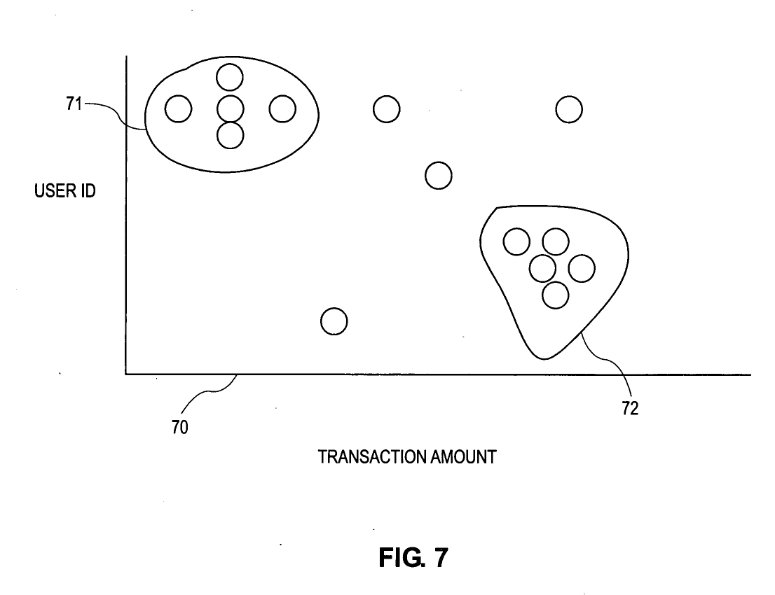

At step 680, once the corresponding journal entries to the anomalous account value are identified, these journal entries are examined and analyzed to identify and learn about the attributes of the journal entries, for example to identify any common characteristics of the transactions or adjustments represented by the journal entries. One way to identify these common characteristics is to run the characteristics of each transaction through a clustering algorithm, for example k-means. For example, all of the transactions identified in step 670 are processed by the clustering algorithm. Clustering algorithms are algorithms which find clusters of similar data points in multi-dimensional data. For example, a clustering algorithm may graph for each transaction the transaction amount 13 against the user ID 18 of the person entering the transaction 14, to identify any patterns of transaction amounts by particular people. A representative graph 70 graphing transaction amount 13 against user ID 18 for each transaction is shown in FIG. 7. Using the graph 70 as an example, the clustering algorithm identifies two clusters 71, 72 where similar transaction amounts were entered by the same person. Other clustering algorithms may graph any or all of the other characteristics of the transactions against each other. For example, a multi-attribute cluster might analyze the transaction category (e.g. credit/debit) against the account age (new/existing) against the form of the transaction (online/Accounts Receivable memorandum/supervisory override/etc.) against the user ID of the person who entered the transaction. An example cluster from such a multi-attribute analysis might group all the entries that match the description “All journal entries that are credits, are not coded as new accounts, are coded as AIR Cash/Credit memo applications, and are entered by user ID 2233.”

Another way to examine and analyze these transactions is to find rules that can be applied to the characteristics of the transactions to distinguish transactions that result in anomalous account values from those that result in non-anomalous account values. The transactions are divided into two sets, anomalous transactions and non-anomalous transactions, depending on whether the transactions are linked to anomalous account activity or other anomalies, as determined above. The two sets of transactions are then input into a decision tree algorithm, for example C5.0, or a rule induction algorithm, that can be used to construct a set of rules that describes each set. For example, the decision tree algorithm processes the set of transactions linked to anomalous account activity or other anomalies identified above. In processing this set, the decision tree identifies a set of rules, such that each transaction meets at least one of the rules. This set of rules is then outputted. A similar set of rules is generated for the transactions linked to non-anomalous account activity or other non-anomalous data. The rules that are output are similar to the common characteristics identified in the descriptions of the clusters above. Once generated, these rules may be more succinct and easier to use, because the rules include only the characteristics relevant to the operation of the rules, i.e. those characteristics in the input transactions that have been determined by the decision tree algorithms to be good predictors of whether the transactions are likely to result in an anomalous account value.

Once the clustering algorithms have identified the common characteristics of the anomalous data points, such as the transactions known to generate the anomalies in the activity, or the decision tree algorithms have identified the set of rules that describe the characteristics of the anomalous data points, then at step 690, the common characteristics of each cluster are compared with characteristics predictive of risks of material misstatement due to fraud, such as the characteristics of clusters of transactions or the set of rules generated from analyses of companies known to be fraudulent. For example, data retrieved from a company where fraud is already known to have existed is analyzed using the method of FIG. 6, to identify anomalous account activity and then identify the common characteristics or set of rules of the underlying transactions which contributed to the anomalous account activity. Alternatively, the financial data from known fraudulent companies may be analyzed using other methods, such as the classical forensic investigative techniques discussed above, to identify such predictive characteristics or sets of rules. As a further alternative, such predictive characteristics or sets of rules which are believed for any other reason (such as experience of an auditor, statements made by fraud perpetrators, common sense, etc.) to be useful to identify risks of material misstatement due to fraud are identified and are used to compare with the common characteristics or sets of rules identified in step 680.

For example, the common characteristics or rules derived from the anomalous data points in the data being analyzed are matched to characteristics or rules derived from known cases of fraud, and Bayesian methods are used to assess the probability that the observed collection of anomalies was generated by a population of journal or account entries similar to historically observed fraud. In this example, a model is constructed to represent the principal areas of fraud risk, for example Premature Revenue Recognition, Overstated Inventories, Overstated Assets, etc., for the purposes of grouping detected anomalies into meaningful sets by relating them to known or suspected fraud schemes. These models encode the primary indicators of these fraud types, as obtained from various sources such as the auditors themselves, analysis of known fraudulent data, industry reports, etc.

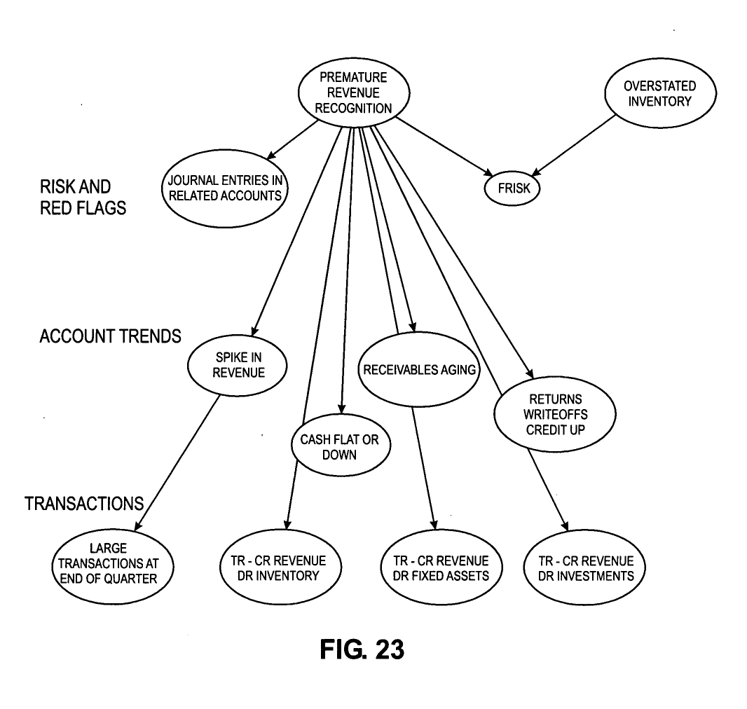

FIG. 23 shows a portion of the model dealing with the risk of Premature Revenue Recognition. Relevant elements include:
Trends—such as Spike in Revenues and Increase in Write-Offs, Credits and Returns
Transactions—(CR) Revenue (DR) Inventory (transactions that credit the Revenue accounts and debit the Inventory accounts)
Risk Factors—FRISK scores, Journal Entries, Round Numbers

The organization of the model ties the anomalies discovered by the methods discussed above together into related sets by linking them to fraud scheme hypotheses for currently known types of fraud schemes. Note that the methods discussed above can also uncover entirely new fraud schemes and the indicators for these schemes. Thus the models can be updated with the findings derived from using these methods on data under analysis.

An initial prioritization of these sets may be generated based on the underlying Bayesian representation of the model. Bayesian networks (also called belief networks, Bayesian belief networks, causal probabilistic networks, or causal networks) are acyclic directed graphs in which nodes represent random variables and edges represent direct probabilistic dependencies among them. For example, in the graph of FIG. 23, the random variable “Large Transactions at End of Quarter” is linked to the random variable “Spike in Revenue” which is linked to the fraud risk “Premature Revenue Recognition”. Thus if an analysis of financial data reveals a common characteristic or rule that correlates to Large Transactions at End of Quarter, there is an increased likelihood that Spikes in Revenue have occurred, which increases the chances that Premature Revenue Recognition has occurred. The more of the risk factors depending from a particular fraud scheme that are found in a data set being analyzed, the greater the risk that this particular fraud scheme has been perpetrated.

If X represents anomalies detected, and F represents fraud schemes, then we want to solve for the probability that F has occurred, given the existence of X:
P(F|X)=(P(X|F)*P(F))/P(X)
Where
P(X|F)=the probability of finding the anomaly X in fraudulent data
P(F)=the probability of the fraud F occurring over all possible data sets
P(X)=the probability of the anomaly X occurring in all possible data sets

A Bayesian network represents the quantitative relationships among the modeled variables. Numerically, it represents the joint probability distribution amongst them. This distribution can be described efficiently assuming probabilistic independencies among the modeled variables. Each node in the network is described by a probability distribution conditional on its direct predecessors. Nodes with no predecessors (such as observed anomalies) are described by prior probability distributions.

Note that the probabilities P(F) and P(X) above are ideally determined over all possible data sets. However, since this computation is frequently difficult to make, an acceptable approximation can be obtained by computing the actual ratios of fraudulent data sets found in a known universe of data sets, such as the universe of all data sets analyzed by the accounting firm using the methods disclosed herein. Similarly, the actual ratios of occurrence of particular anomalies found in the known universe of data sets is an acceptable approximation for the probability P(X) discussed above.

The results of the comparison are reported to the auditor at step 695, giving a higher weighting or priority to those clusters of transactions or activity, or sets of rules, from the data being analyzed which are most similar to the characteristics, clusters of characteristics or sets of rules identified as being predictive characteristics or rules, as discussed above. A higher weighting may also be given to those clusters of transactions or activity or sets of rules which contain a greater mean degree of anomaly. The auditor may then investigate this limited subset of all of the transactions of the business entity, using other methods such as interviewing the people identified by the user IDs 18 who entered the transactions 14 with amounts 15, or reviewing other corporate records about those transactions 14, or any other investigative technique practiced by the auditor.

By following the method of FIG. 6, a CAAT system is able to distill the thousands or tens of thousands of account activities, and the millions, tens of millions, or hundreds of millions of underlying transactions which generate the account activity, down into a manageable number of leads to further investigate to assist in identifying whether there are any risks of material misstatement due to fraud. The method of FIG. 6 avoids the problems with applying a purely statistical analysis to financial data, and the resulting overload of data. The method of FIG. 6 further avoids the problems with applying a purely rules-based artificial intelligence analysis, and the resulting difficulties in scaling and maintaining such a system. By first applying a statistical analysis to identify anomalous data points, and then applying an artificial intelligence analysis to identify common characteristics or sets of rules for the transactions which generated the anomalous data points, and then comparing those identified common characteristics or rules with corresponding characteristics or rules that identify risks of material misstatement due to fraud, the CAAT system of the embodiment of FIG. 6 is able to efficiently and accurately process very large amounts of financial data to identify the most promising subsets of that data which are most likely to be indicators of such risks.

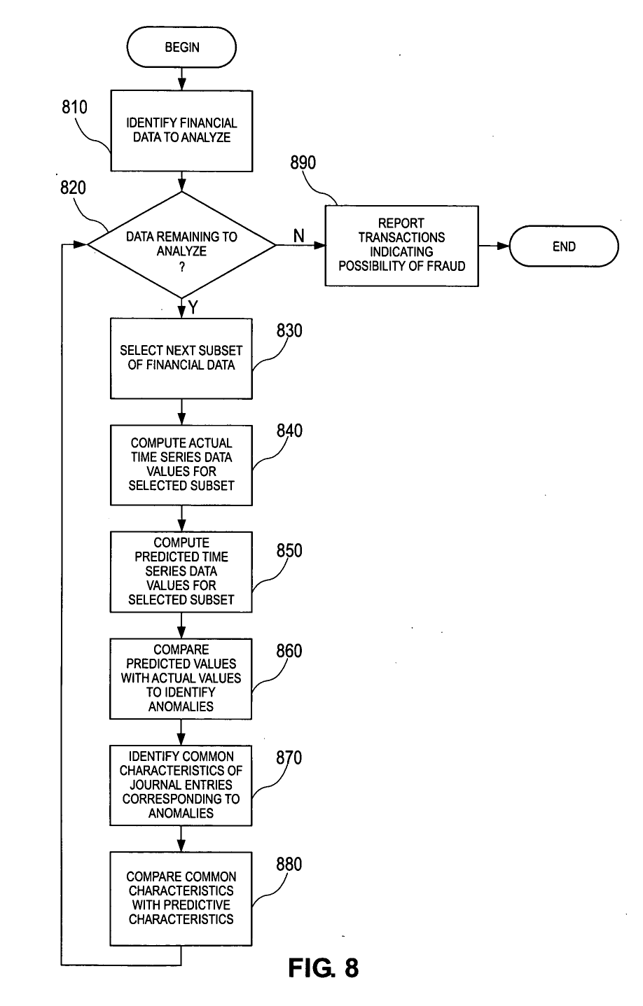

In alternative embodiments, the steps of the method of FIG. 6 may be performed in parallel, or iteratively, or in other different orderings. For example, turning to FIG. 8, a method of identifying risks of material misstatement due to fraud according to an alternative embodiment begins at step 810 by identifying the collection of financial data to be analyzed, such as the accounts of a typical accounting system of a business entity. At step 820, a check is made to determine if there is any financial data remaining to be processed. Assuming there is data remaining to be processed, then at step 830 the next subset of financial data (such as an account in the accounting system) is selected for processing. At step 840, one or more time series are computed as discussed above, for the actual values of the subset of financial data. At step 850, one or more time series are computed as discussed above, for the predicted values of the subset of financial data. At step 860, the predicted and actual values for each point in the time series are compared with each other as discussed above, to identify anomalies in the actual values (e.g. where the actual values differ from the predicted values). At step 870, common characteristics of the anomalous data points are identified, for example by using the clustering algorithms discussed above. At step 880, these common characteristics are compared with predictive characteristics, as discussed above, to identify such potential risks. Control then returns to step 820, where the next subset of data is retrieved for processing by the method. At step 820, the results generated in prior iterations of the method may be used to aid in determining the next subset of data to analyze. For example, if the prior iterations identify in one subset of data a particular characteristic that indicates a risk of material misstatement, then at step 820, another subset of data that also includes that characteristic may be selected as the next subset of data to analyze. Once all of the data has been processed, then at step 890, the identified transactions are reported to the auditor for further action, as discussed above.

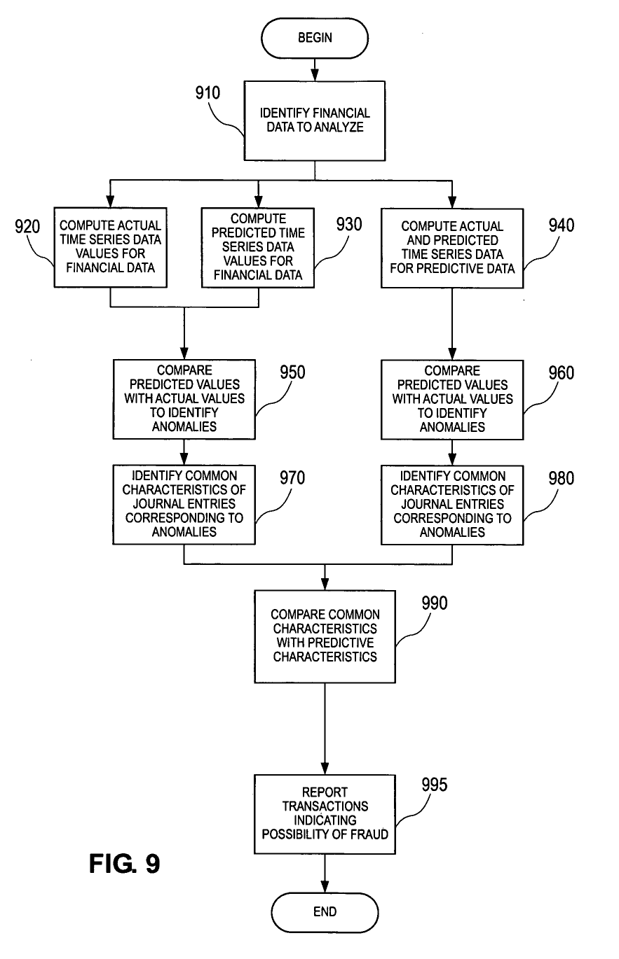

Turning to FIG. 9, an alternative method for identifying risks of material misstatement due to fraud, operating in parallel, is shown. The method begins at step 910, by identifying the collection of financial data to be analyzed, such as the accounts of a typical accounting system of a business entity. Then in parallel, at steps 920, 930 and 940, actual time series data values for the financial data (step 920), predicted time series data values for the financial data (step 930) and actual and predicted values for the predictive data (step 940) are all calculated, in a similar manner as discussed above for FIG. 6. At step 950, the actual and predicted values for the financial data are compared with each other, to identify anomalies. This comparison may be done as soon as steps 920 and 930 begin generating data values. Similarly, at step 960, the actual and predicted values for the predictive data are compared with each other, to identify anomalies. At step 970, the anomalous financial data is processed, for example by the clustering algorithms discussed above, to identify common characteristics of the anomalous data. This clustering analysis may be commenced as soon as step 960 has begun generating anomalous data values. Similarly, at step 980, the anomalous predictive data is processed to identify common characteristics of the anomalous predictive data. At step 990, the common characteristics of the financial data and the anomalous predictive data are compared with each other, to identify possible risks of material misstatement due to fraud in the financial data, as discussed above.

The multivariate regression analysis discussed above may become computationally expensive. The analysis can be optimized using techniques such as incremental calculation, or subset selection. Because of the structure of the time series data, the equation used to calculate the regression coefficients can be expressed as a recursive equation, which allows the computation process to reuse the coefficients calculated for previous values in computing the coefficients for successive values. Therefore, for each coefficient in the equation, only the additional incremental factor above the prior values must be computed (as opposed to re-computing the entire coefficient for every point in time in the time series). This results in a significant gain in efficiency, several orders of magnitude reduction in computation time for an 80 MB dataset, for example.

Furthermore, by selecting a subset of all of the data points in a time series, rather than using the entire time series, the number of terms in the multivariate regression equation can be pruned significantly. Most of the data in the time series other than the time series for which the present value is being computed will be irrelevant in predicting the value of that time series. A measure of expected estimation error can be used to prune the set of time series to a much smaller subset with little cost in accuracy but often greater than one or more orders of magnitude in efficiency. The expected estimation error value is computed instead of computing all of the data in the other time series, which saves significant computation time. As a bonus, this measure of expected estimation error can be calculated incrementally as well, using the incremental calculation methods discussed above.

An additional way to optimize the multivariate regression analysis discussed above, by limiting the number of terms in the regression equation, is to limit the number of different time series which are processed by the multivariate regression analysis. One way to limit the time series is discussed above, using an expected estimation error of a time series as a substitute for the entire time series data stream. Another way to limit the number of terms in the regression analysis is to perform the analysis only over a relatively small subset of all of the time series data. For example, selecting a small number of accounts from the entire universe of accounts contained within the financial data of a typical company under review will significantly speed up the computation of the multivariate regression equation.

One challenge to this approach of selecting a small number of accounts is found in determining which accounts to select. It is desirable to select a useful subset of accounts, in order to generate meaningful results from the multivariate regression analysis, while keeping the subset small enough for rapid computation of the equations. There are several potential examples of what a useful subset might be. One example is to categorize accounts by their role in the financial statement, such as all revenue accounts or all asset accounts. Another useful subset might be accounts that behave similarly to each other, for example in terms of volume of transactions through those accounts, or other accounts they are related to through transactions. Another subset might be the accounts that account for the majority of the variance in general ledger activity.

As discussed in greater detail above, the business transactions of a typical company are recorded in journal entries in the journal for the company. These journal entries are periodically posted to the accounts contained in the company's general ledger. Any internal adjustments made to the accounts, e.g. revenue adjustments to ensure that revenues are recognized in the period they are actually earned and expense adjustments to ensure that expenses are recognized in the period in which they are actually incurred, are also posted to the accounts in the general ledger.

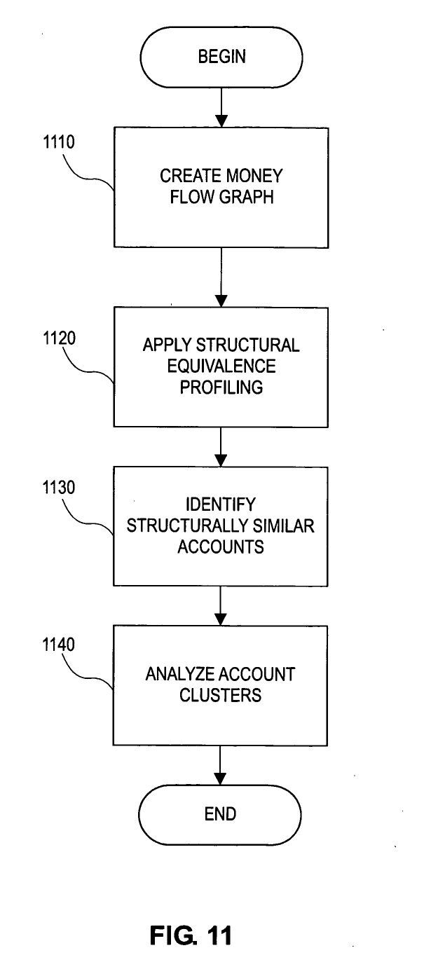

At a high level, one way to determine which subsets to use in the multivariate regression analysis follows the method of FIG. 11. The method begins at step 1110, where a money flow representation, such as a money flow graph or money flow matrix, is created for all of the accounts, or other financial data aggregations, being analyzed. These financial data aggregations could include accounts, groups of accounts, sub-accounts, financial statement line items, or any other way of aggregating together financial data. At step 1120, a structural equivalence profiling is applied to the money flow graph. At step 1130, the results of the structural equivalence profiling are analyzed to identify structurally similar accounts or account clusters, based on the money flows between accounts. At step 1140, these account clusters are subjected to further analysis, such as being used in the analyses of FIGS. 6-10 above, or other types of analysis as discussed in detail below.

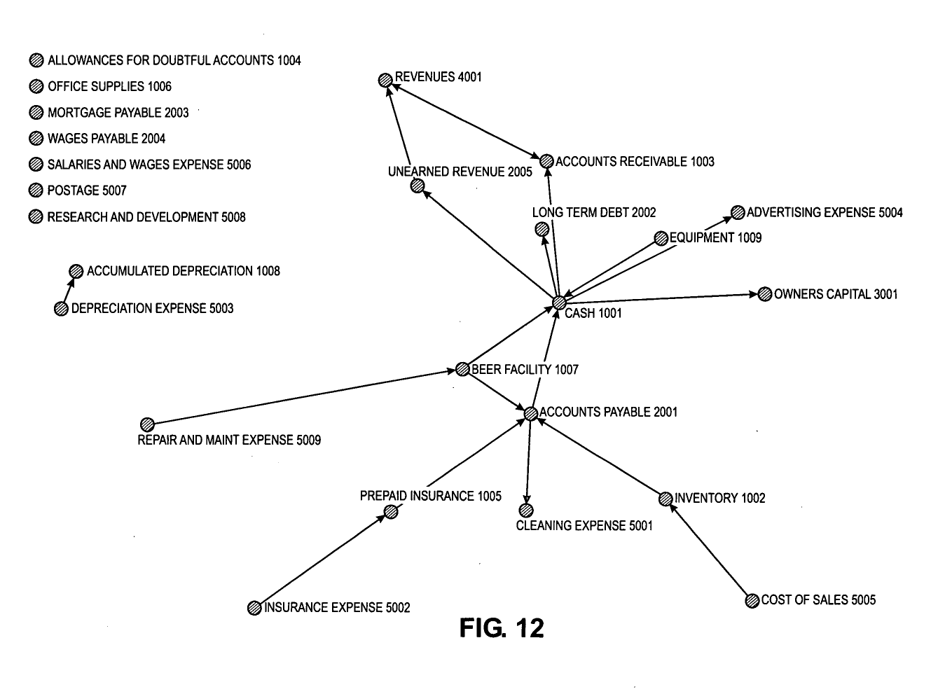

Turning to step 1110 of FIG. 11, the flow of money amongst the accounts of the company can be depicted as a graph, with each account being represented by a node in the graph, and each transfer of money between accounts being represented by a line (known as an edge) connecting a pair of nodes in the graph. For example, turning to FIG. 12, a highly simplified graph of accounts for XYZ Company is shown.

The nodes of the graph in FIG. 12 are derived from the account data, by associating one node with each account in the financial accounting system for XYZ Company. The edges of the graph in FIG. 12 are derived from the transaction data from XYZ Company's financial accounting system, over a given time period. An edge between two account nodes is created if the two accounts appear in the same transaction. The arrows on the edges between each pair of nodes in the graph indicate which direction the money is flowing in the graph. For example, assume that a transaction occurs in which a facility is sold, and paid for in cash. This transaction results in a ledger entry where account 1007 Beer Facility is debited and account 1001 Cash is credited. This entry is reflected by an edge appearing in the graph between the nodes 1001 and 1007 representing those two accounts, with the arrow indicating that the money flowed from account 1007 to account 1001. If unique transactions cannot be identified, e.g. because unique transaction identifiers are not available, then a transaction may be approximated by identifying unique combinations of other data fields found in the transaction data.

In the example above, edges were only created between pairs of accounts for which the transactions being graphed indicated an opposite credit/debit status. Edges were not created for account pairs for which the transaction indicated the same credit/debit status, since there would be no money flow between these account pairs. In alternative embodiments, additional edges can be created, to depict additional relationships between accounts. For example, the additional edges could show that the account pairs appeared in the same transaction, but that there was no money flow between the account pair. This sort of information could be useful to identify pairs of accounts that are typically credited or debited together in the same transaction, for example. Edges showing other relationships could also be created. For example, an edge could link two accounts whenever those accounts appeared in consecutive journal entries, or whenever those two accounts appeared together in journal entries made in the same time period (i.e. on the same day), or to capture any other relationship of interest.

The edges of the money flow graph may depict simple flow paths between accounts during the time period, or alternatively the edges may include additional data, such as the number of transactions, the average dollar value of the transactions, the total dollar value of the transactions or other such data. This data may be used to represent weightings for the edges, for example. The nodes of the money flow graph may represent accounts within the company, or alternatively they may represent other aggregations of transaction or other financial information, such as financial statement line items, consolidated spreadsheet entries, account category aggregations, sub-accounts, or any other aggregation of transaction information useful to the analysis. It is also possible to use the methods of an embodiment to evaluate other types of money flows, for example, instead of having each graph node represent an account that money flowed to or from, it could represent the person who approved or entered the transactions, or the location where the transactions were entered or approved.

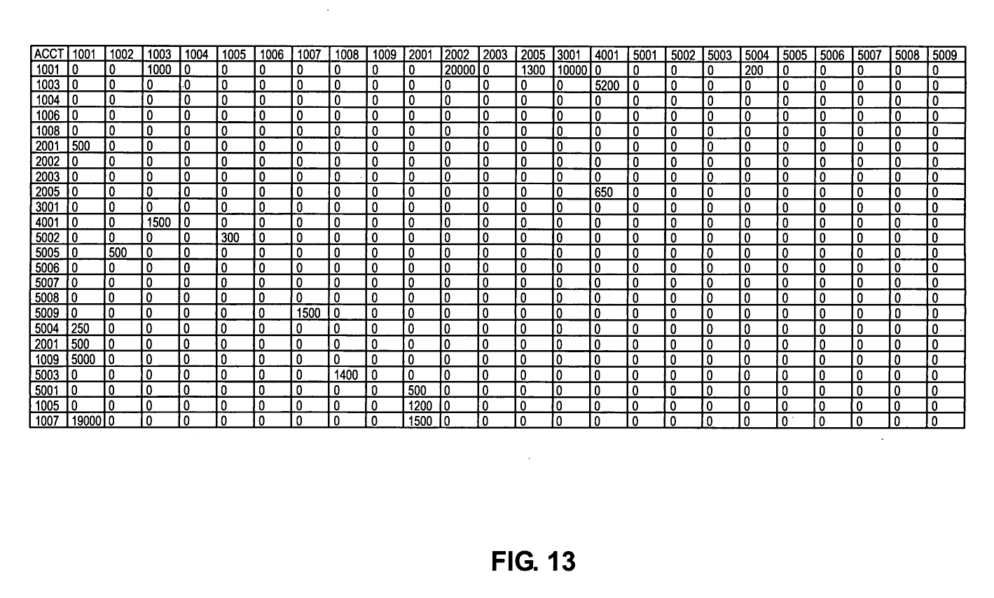

The money flow graph of FIG. 12 can also be represented as a two-dimensional adjacency matrix, as shown in FIG. 13. In FIG. 13, the nodes are listed on both the x and y dimensions of the matrix. The cells contain a value that represents the dollar value of the transactions between each pair of accounts. For example, the cell at row 1, column 3, contains a value of “1000”. This indicates a money flow of $1,000 from the Cash 1001 account to the Accounts Receivable 1003 account. The cells could alternatively contain a value that merely indicates the number of occurrences of the edge between the node in the row and the node in the column. The cells may additionally or alternatively contain other data about the edges, such as the transaction data or weighting data discussed above. The matrix of FIG. 13 is an asymmetric matrix, wherein the direction of the money flow is tracked. In an asymmetric matrix, each cell contains a value that represents the number of occurrences of an edge from the node in the row to the node in the column. Alternatively, a symmetric matrix can be created, which means that the direction of the money flow between any given pair of nodes is not tracked.

Turning to step 1120 of FIG. 11, once the account graph is created, the graph is analyzed to identify structurally equivalent or similar nodes in the graph. Structural equivalence measures the similarity between two different nodes in the graph, based on the connections (edges) each node has with the other nodes in the graph. For example, the accounts 2002 Long term Debt and 3001 Owners Capital are both connected to the same account and would therefore be considered structurally equivalent. At a high level, structurally equivalent nodes can be said to play similar roles in the graph. The basic idea behind structural equivalence depends on ordering the rows and columns of the adjacency matrix to create clusters of accounts in an efficient way. For a more sophisticated evaluation of equivalence, additional data about the edges, such as the number of connections between the first and third nodes (and/or second and third nodes), or the average dollar value of the transactions represented by the edges, or the aggregate dollar value represented by the edges, or other information about the edges, may be incorporated into the determination. In an embodiment, the adjacency matrix of FIG. 13 above is provided as an input to a structural equivalence profiling algorithm such as the algorithm contained in the UCINET social network analysis package, available from Analytic Technologies, Inc. of Harvard, Mass.

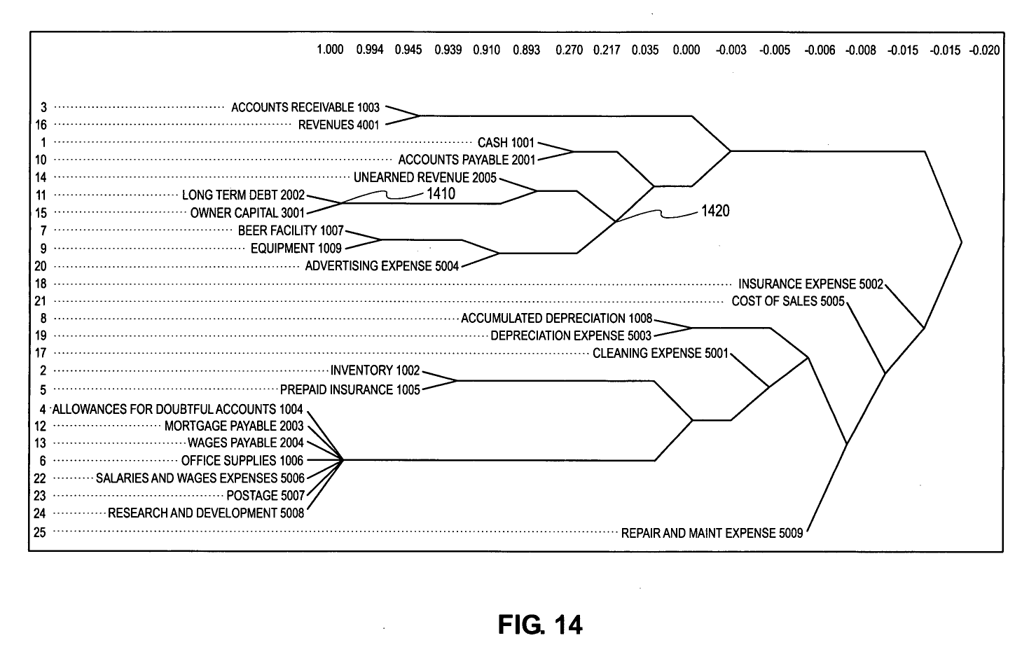

The structural equivalence profiling algorithm creates a representation of the relative similarity of each of the nodes in the graph to each other. This representation may take the form of a tree representation, as shown in FIG. 14, or an outline representation or any other convenient form of representing this information. The account similarity tree of FIG. 14 includes a listing of the accounts being represented down the left side of the figure. The numbers across the top of the figure represent the relative degree of similarity between the nodes which are joined at each given tree node. For example, the accounts Long-Term Debt 2002 and Owners Capital 3001 have a high degree of similarity, as reflected by the node 1410. The accounts Accounts Receivable 1003 and Revenues 4001 are also similar to each other, but by a lesser degree. This similarity also can measure how similar clusters of accounts are to each other. For example, the cluster of accounts Beer Facility 1007, Equipment 1009 and Advertising Expense 5004 is similar to the cluster of accounts Long Term Debt 2002, Owners Capital 3001 and Unearned Revenue 2005, as shown by the node 1420.

Once the money flow graph 1200 is processed through the structural equivalence profiling algorithm, the output, such as the tree of FIG. 14, represents a clustering of the accounts based on the network structure of the graph, created by the money flows of the transactions, between the accounts. Such a representation allows the accounts to be clustered together into groups of related accounts, without needing any understanding of how the company whose financial data is being evaluated operates, nor how the general business model of the company or the industry it is in functions. Additionally, no understanding of the characteristics, labels, or definitions of the accounts themselves is needed to generate meaningful clusters of accounts.

Turning to step 1130 of FIG. 11, the resulting clusters of accounts may be used for a variety of analytical purposes. One use for the structural equivalence profiling is to identify useful subsets of accounts to process further, using the methods for identifying risks of material misstatement due to fraud, discussed herein. For example, at step 610 of FIG. 6, where the set of financial data to be analyzed is identified, instead of analyzing the entire set of financial data for XYZ Company, including all of the accounts and underlying journal entries, the structural equivalence profiling discussed above is used to prune the accounts down to a useful but manageable set of accounts to analyze.

According to one embodiment, meaningful results can be derived using the methods for identifying risks of material misstatement due to fraud discussed above, by selecting a relatively small subset of accounts, such as approximately five accounts. The structural equivalence profiling techniques are used to ensure that the small subset selected is a subset where the members are sufficiently related to each other to generate meaningful analytical results.

There are other business uses for the structural equivalence profiling of accounts. For example, a review of the structural equivalence profile can reveal unusual or suspect accounts, where the actual usage does not match the intended usage as identified by the account name or other labeling information. For example, an account that is labeled as a “revenue” account, but that is structurally equivalent or similar to a cluster of expense accounts, or asset accounts, might be mislabeled, or there may be deliberate misuse of this account going on. This mislabeling or misuse is revealed when the suspect account appears in a cluster it was not expected to appear in, based on the labeling or other data reflecting its intended use.

The structural equivalence profile also reveals useful information about the business model of the company whose accounts are being reviewed. This information can be used to make business decisions, such as streamlining business processes, consolidating or dividing business units based on transaction flows, eliminating redundancies, etc. For example, if the structural equivalence profile reveals that several accounts in different business units of the company all behave similarly in terms of money flows, this could suggest that any business decisions made that affect one of these accounts should be applied to all of the accounts. Additionally, this could suggest that these accounts should be grouped together as a business unit, or that these accounts should all be administered by the same person or department.

A further approach to analyzing transaction activity over the entire general ledger for a given time period is the creation of an activity heat map which shows how the transaction activity is distributed over different combinations of debited and credited accounts, or other financial data aggregations. Recall that the general ledger includes information about the activity in the various accounts or other financial data aggregations of the company. The accounts are credited and debited by the various financial transactions that are entered into the financial accounting system. This transaction activity causes the account balances to fluctuate over time, as money is credited and debited.

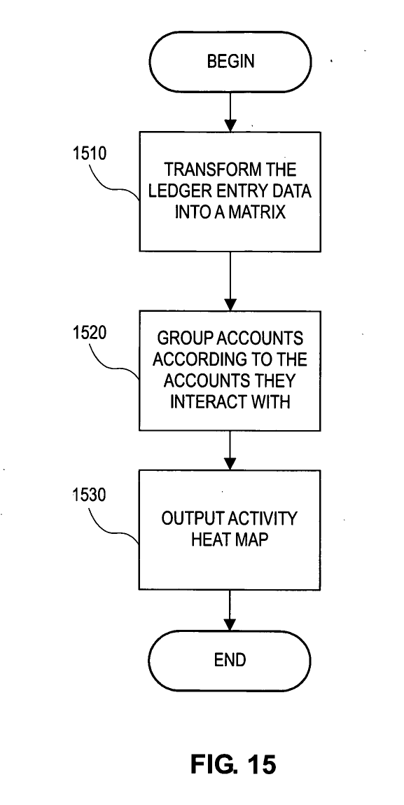

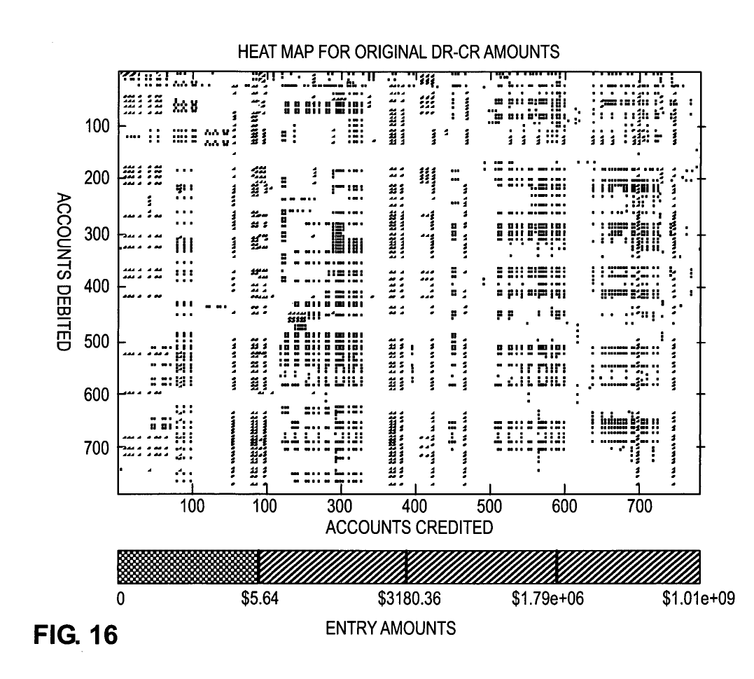

The steps involved creating activity heat maps are shown in FIG. 15. At step 1510, transform the ledger entry data into a matrix representing the combinations of debited and credited accounts in the transactions. Construct a 0-1 valued matrix with each row representing accounts that were debited, and each column representing accounts that were credited. The resulting matrix contains a 1 in the (i,j)th cell if Account i was debited and Account j credited in a single transaction. An example of the resulting matrix, created by the transformation is shown in plot of FIG. 16. The account numbers that are the scales on the x and y axes range from 1 to 784, because there are 784 separate accounts in this data set. The plot of FIG. 16 includes transaction amount data, which also represents the 0-1 values discussed above (any transaction amount above 0 is treated as a 1). In the plot, each black pixel indicates that in some transaction, account i (row) was debited, and account j (column) was credited. This represents a flow of funds from one account to another. The darker the pixel at any given point, the greater the dollar value of the transaction.

At step 1520, using a cross-associations algorithm, the accounts are then grouped according to the other accounts with which they interact. Account groups are created for the accounts that are debited and also for the accounts that are credited. This gives a group of accounts that exhibit similar behavior in terms of the accounts that each member of the group interacts with. An example of a cross-association algorithm is presented in Chakrabarti, D., Modha, D. S., Papadimitriou, S., Faloutsos, C., Fully Automatic Cross-associations, in Proceedings of the Tenth ACM SIGKDD International Conference on Knowledge Discovery and Data Mining. (2004), which is hereby incorporated herein by reference, in its entirety. This algorithm is a joint-decomposition of a binary matrix into disjoint row and column groups such that the rectangular intersections of row and column groupings are substantially homogeneous. The cross-associations algorithm uses an information-theoretic criterion (MDL—minimum description length) for grouping similar transactions and accounts together. At a high level, the cross-associations algorithm begins with a binary matrix, and seeks to partition the matrix into rectangular intersections of rows and columns (i.e. clusters) of matrix entries which are substantially homogeneous. The algorithm does this by alternately re-ordering the rows and then the columns of the matrix to create clusters, and then further re-ordering the rows and columns to decompose the clusters down into smaller clusters, which become increasingly homogeneous. The cross-associations algorithm can create clusters based on the 0-1 values, or can alternately use other available data, such as the transaction amounts discussed above, to create the clusters. Further details of the algorithm can be found in the incorporated Chakrabarti reference.

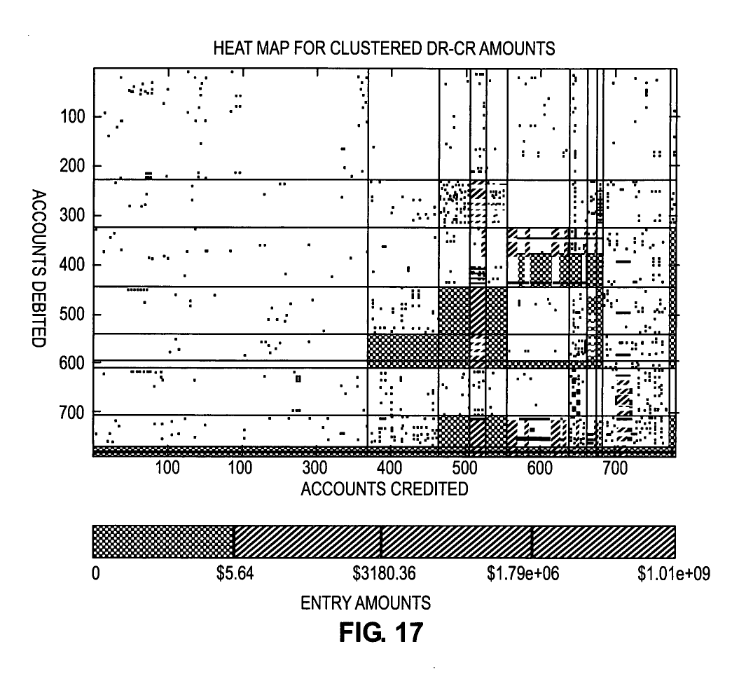

An example of the results of applying the cross-associations algorithm to the information from FIG. 16 is shown in FIG. 17. The rows and columns of FIG. 16 have been re-ordered by the cross-associations algorithm to show the clusters of accounts. The clusters of accounts are shown by the rectangles contained within the graph. The smaller the rectangles, the more closely related are the accounts within the graph. For example, the clusters at the lower right of FIG. 17 are more closely related than the clusters at the upper left of the graph. Again, the darker the pixels, the greater the dollar value of the transactions.

At step 1530, the results from the cross-associations algorithm give groups of accounts whose roles are functionally similar, which are outputted as an activity heat map. This helps identify account subsets that can later be analyzed together, using any of the methods discussed herein. The results from the cross-associations algorithm may also be used to construct an account similarity tree, such as the tree of FIG. 14. Further analysis, as discussed above, may be performed on that tree.

These subsets correspond to business intuitions as well. For example, cluster 1710 in the example of FIG. 17 includes accounts which represent or are closely correlated with labor costs. Note that the shading used to indicate the dollar value amounts, as shown by the “Entry Amounts” at the bottom of FIGS. 16 and 17, uses a logarithm scale. This is a useful feature of this embodiment of the invention, as the log scale reduces the impact that a few isolated transactions of disproportionate size could otherwise have on the analysis. This is one example of how the data is processed or smoothed, to refine the analysis and generate more accurate results.

Structural profiling and activity heat maps are used to select a small subset of accounts to analyze together because models with smaller numbers of variables have been shown to yield more statistically stable results than models with larger numbers of variables and such models are analyzed more quickly and easily. An alternative to selecting a subset of accounts to reduce model size is to transform the entire set of data so that the information necessary for anomaly detection might usefully be represented with a smaller number of variables. Principal component analysis (PCA) is one such method for data transformation and is well understood in statistics, for example in I. T. Jolliffe, Principal Component Analysis, (Springer Verlag 2002), which reference is incorporated herein by reference, in its entirety.

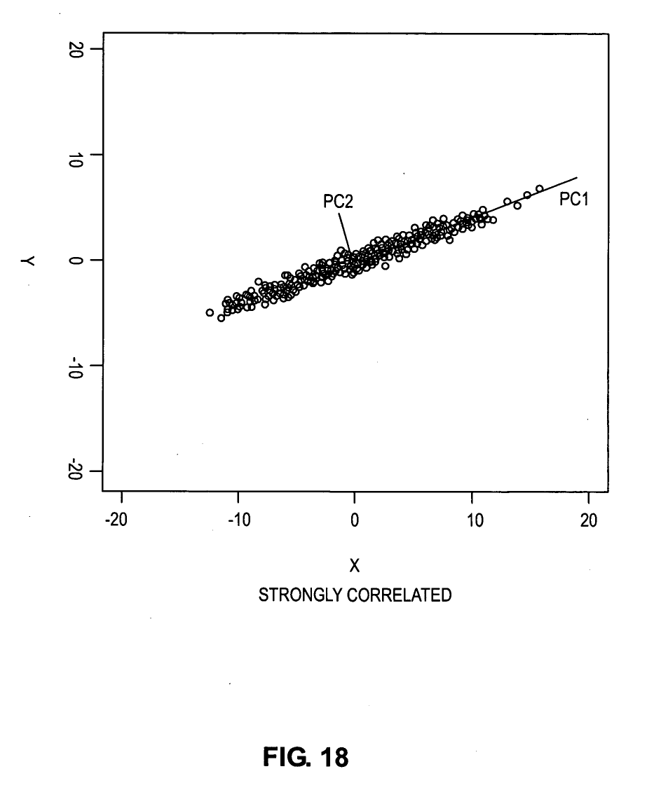

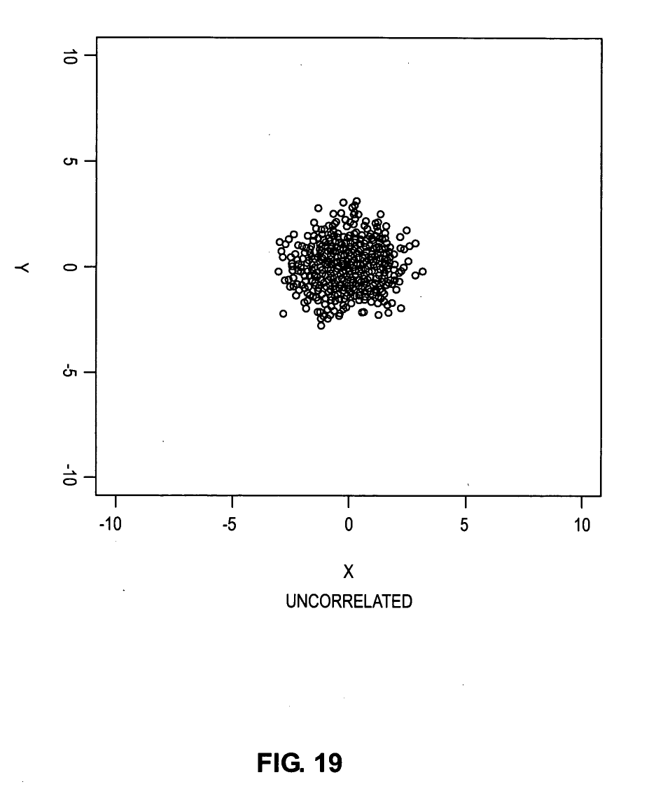

At a basic level, principal component analysis is a data reduction technique. The goal of principal component analysis is to reduce the number of dimensions of multi-dimensional data, while retaining the variations in the data. This is done by mapping the original set of variables into a new set of variables, which are uncorrelated and ordered according to the variation found in the data. Each of the new set of variables is a principal component, and is a linear combination of the original variables/dimensions. Each principal component captures an aspect of the total variation within the data set being analyzed. The total variation can be closely approximated as a set of equations, with each equation representing one principal component. The first principal component represents the vector along which the largest variation is seen in the data set being analyzed. The second principal component represents the vector along which the second largest variation is seen in the data set, and so on. These principal components can be computed using well known techniques such as singular value decomposition (SVD) or a neural network. Principal component analysis is more effective at data reduction when a strong correlation exists in the data. For example, principal component analysis is more effective at data reduction on the data plot of FIG. 18 than on the data plot of FIG. 19. The first principal component (PC1) is shown by the line along the axis of maximum variance in the data set. The second principal component (PC2) is shown by the line orthogonal to PC1. Further principal components could also be computed as desired, depending on the amount of the total variance desired to be retained.

Reducing a dataset containing large numbers of accounts, for example, down to a manageable number of principal components, does result in some loss of variance (or energy), but it has been found to be possible to retain 80% of the variance in a financial data model while reducing the number of variables by approximately 80-90%.

In an embodiment, principal component analysis is applied to the collection of time series derived, as described above, from the changes to each account in the general ledger over time. The anomaly detection algorithms described above are then applied, to only the first few (for example ten) principal components to detect dates on which there are sudden changes in coefficients of the terms. As above, these dates are then flagged as anomalies and are then used as inputs by the algorithms discussed above that compare the entries on the anomalous dates to the entries on the previous dates, as well as the other algorithms used to process the anomalous data, such as to determine potential reasons for the anomalies, common characteristics of the anomalies, or compare the anomalous data to fraud predictive data. Use of the smaller number of principal components instead of the large underlying collection of time series data streamlines the anomaly detection process significantly, because the anomaly detection algorithms are processing significantly less data, without losing significant levels of accuracy.

In addition to using principal component analysis to streamline the computations in the other algorithms discussed herein, the principal component analysis itself also may reveal patterns that indicate risks of fraudulent manipulation. In one embodiment, principal component analysis is applied to a matrix derived from the general ledger with n rows and k columns, where n is the number of days, and k is the number of accounts, and each entry in the matrix represents the total change to one account on one day. Alternatively, the matrix entries could represent the number of transactions affecting the account, or the average value of the transactions affecting the account, or any other such information about the transactions.

Each principal component gives the set of coefficients each matrix entry for the day (i.e. the change in each account for that day) is to be multiplied by. The size of each coefficient represents the importance of that particular variable (i.e. account) to the principal component being computed. The sum of the terms of the principal component equation is the value of the principal component for all accounts on that day. For example, if on day 1, for a matrix with 2 accounts, the changes in account values were (80, 350), and the first principal component equation was PC1=0.2136 * A1+0.9769*A2, then PC1 would equal 17.088+341.915=359.003 for day 1. Similarly, if the second principal component equation was PC2=0.9769* A1−0.2136*A2, then PC2 would equal 78.152−74.76=3.392 for day 1. Similarly, using the changes in account values shown in Table 1 below, the first and second principal components would have the values shown in Table 2 below.

TABLE 1

| Day | A1 | A2 |
|---|---|---|
| 1 | 80 | 350 |
| 2 | 50 | 250 |
| 3 | 20 | 40 |
| 4 | 75 | 350 |

TABLE 2

| Day | PC1 | PC2 |
|---|---|---|
| 1 | 359.003 | 3.392 |
| 2 | 254.905 | −4.555 |
| 3 | 43.348 | 10.994 |
| 4 | 357.935 | −1.492 |

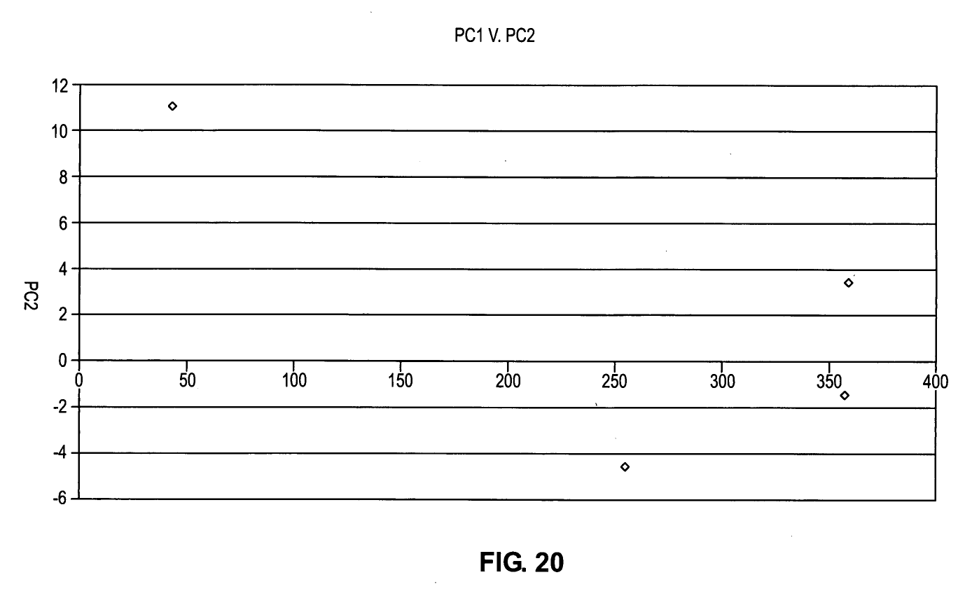

Then we plot the value of the first principal component against the second principal component, where each point represents PC1 vs. PC2 for one date. An approximation of the plot of PC1 and PC2 from Table 2 is shown in FIG. 20. As can be observed, the point from Day 3 is an outlier to the points from days 1, 2 and 4. Additionally, turning back to the plot of FIG. 18, outliers can be seen at either end of the line showing PC1.

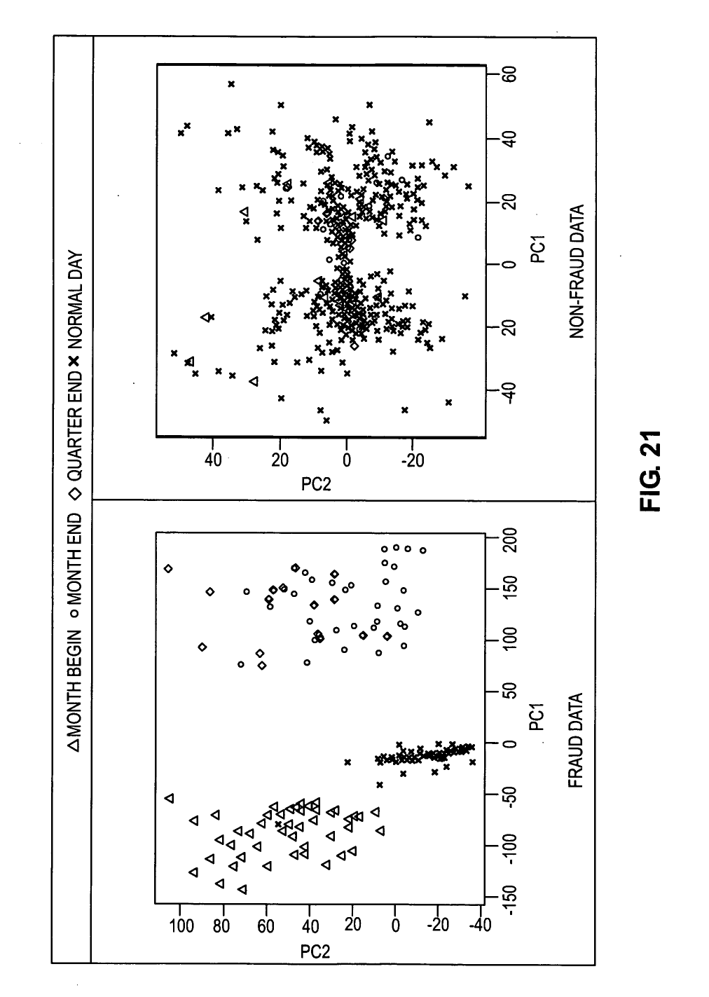

The plot of FIG. 20 is a very simple example of this sort of analysis. The plots of FIG. 21 show more robust data sets which demonstrate the usefulness of the analysis of an embodiment of the invention to detect clusters and outliers based on the dates transactions were made. Each date is coded by both color and shape according to whether it is an end of the month, first day in the month, end of year or quarter, or any other day. If these different types of days form clear clusters or outliers, it may indicate systematic manipulation of the general ledger based on the date. The absence of clear clusters or outliers may indicate the absence of such manipulation (but see the discussion of permutation testing below). The fraud data shows clear clustering based on whether the data was entered on the first day of the month, the last day of the month, or the last day of a quarter, or on any other day of the month. The clustering is highly specific to types of dates, with high values on month and quarter ends, and low values on month beginnings. Unusual patterns of activity on these dates suggests the possibility of fraudulent manipulation. On the other hand, the non-fraud data plot shows no such clustering.

To increase the efficiency and accuracy of this principal components analysis to detect clusters and outliers in this fashion, the data may be pre-processed in several ways. First, drop the zero days from the matrix, by removing all the rows where the transaction amount is 0 for all the accounts. The zero days are likely to put more weight on the origin, although there is no activity there, which will adversely affect the principal component analysis. The second step is to smooth the data by taking the fifth root of the amounts in each entry in the original data matrix. This mitigates against the possibility that a few large amounts will dominate the whole analysis. Because some of the amounts may be negative, the more standard smoothing operation of taking the logarithm will not work for the entire series; taking the fifth root (or any other odd-root such as third root or seventh root) works for negative as well as positive values. Alternatively, other data smoothing techniques may be used as long as they are able to smooth the data accurately for all possible data values. Finally, the data is normalized, resealing it so that each column representing one account has a zero mean (by shifting all values up or down so the mean is zero) and unit variance (s²=1) (by multiplying all values by a chosen constant c, such that the variance becomes 1). Even after smoothing, the range between the minimum and maximum values for each account may still be quite different for different accounts, so to facilitate comparison across different accounts, the data is normalized by rescaling all of the data to the same range.

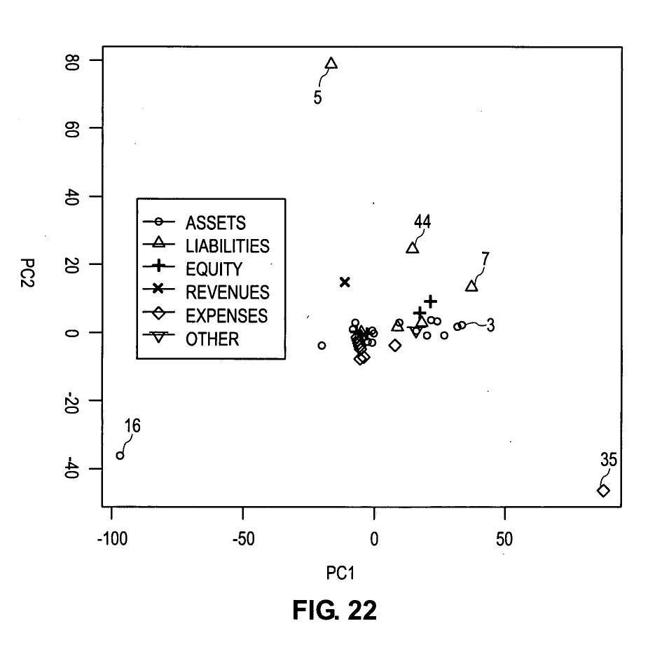

In another embodiment of data transformation using PCA, principal component analysis is applied to a time matrix derived from the general ledger, with n rows and k columns, where n is the number of accounts, and k is the number of days, and each entry in the matrix represents the total change to one account on one day. In this embodiment, each principal component gives the set of coefficients the change on each day is to be multiplied by; the sum of the terms is the value of the principal component for that account over all of the days under analysis. Then the first principal component is plotted against the second, where each point in the plot represents one account. Most of the points will cluster together. Points that are farthest away from the center of the cluster, the outliers, represent accounts that contribute the most to the variation in the balances of the accounts that make up the general ledger, and may be candidates for further scrutiny. An example plot is shown in FIG. 22. The numbered points represent accounts that are responsible for a high degree of variation in amounts over the entire general ledger.

In addition to examining the plots generated in the principal component analysis to detect clusters, as discussed above, the principal component data may also be analyzed using a permutation testing analysis. The permutation testing is conducted to determine whether the set of points representing the data from particular dates of interest, such as an end of the month, first day in the month, end of year or end of quarter are from the same data distribution as the data from the other days in the time period. If the data from the particular dates of interest are not from the same data distribution as the data from the other days in the time period, this may indicate systematic manipulation of the general ledger based on the date. However, if the data from the particular days of interest are from the same data distribution, this may indicate the absence of such manipulation. Permutation testing is a useful analysis to run on data such as the principal component analysis plots discussed above, either as a secondary or confirmation test to confirm the results of the clustering review discussed above, or to analyze data where fraud is suspected but no clustering was observed. Permutation testing is also useful to run on data where clustering was observed, to identify the cause for the clustering, or to rule out a cause for clustering. Permutation testing may also be used on other data sets, such as the data generated for the other analysis methods discussed herein.

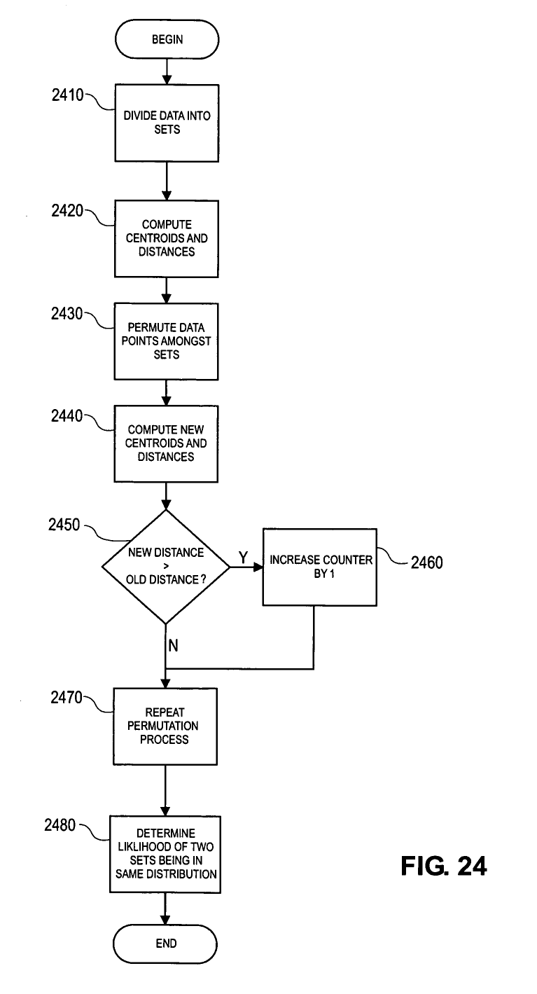

The method of FIG. 24 shows the steps to performing a permutation test on a set of transaction data according to an embodiment of the invention. At step 2410, the data is divided into two or more sets, according to one or more criteria of interest, such as the date of the transaction. For example, transactions for the last day of the month and transactions from the data from the other days in the month are grouped into separate sets. At step 2420, the centroid (mean value) of each set of points is computed, and the distance between the two centroids is measured. At step 2430, all of the data points are randomly re-assigned into one of the two sets created in step 2410, maintaining the sizes of each set the same as before. At step 2440, the centroids of these two new sets are computed, and the distance between the two new centroids is measured. At step 2450, the distance between the two new centroids is compared to the distance between the two old centroids. At step 2460, if this new distance is greater than the distance between the two old centroids, then a counter is increased by one. At step 2470, steps 2430 through 2447 are repeated multiple times (for example several thousand times), with random re-assignments performed each time.

At step 2480, the value in the counter is examined, and a determination is made of the liklihood that the two sets of data are from the same data distribution. As discussed in detail below, the smaller the value in the counter, the less likely it is that the two sets of data are from the same data distribution. If it is determined that the two sets of data are from different distributions, this information can be used to further analyze the financial data, for example to determine the reasons why the data reflecting transactionson the last day of the months is from from a different distribution than the rest of the data, using for example any of the methods discussed herein.

For the data distributions, there will be two general cases. If the distribution of points in the first set (of dates from the end of the month in this example) and the distribution of points in the second set (of dates from other days of the month) are different, then the points in each distribution are likely to be separated from the points in the other distribution. When the points are randomly re-assigned between the two sets, it is quite likely that some of the points will be reassigned to the other set, thus shifting the centroid of each set. The centroids of the new sets will likely be closer together than the centroids of the old sets. Thus, the distance between the new centroids is likely to be less than the distance between the old centroids. Even in the case where the random re-assignment of points causes all of the points to be assigned back to their original locations, the difference in distances between centroids will be zero. Thus, since the counter is only increased when the distance between the new centroids is greater than the distance between the old centroids, this counter value will be very low for the case where the distributions of the two sets of points is different.

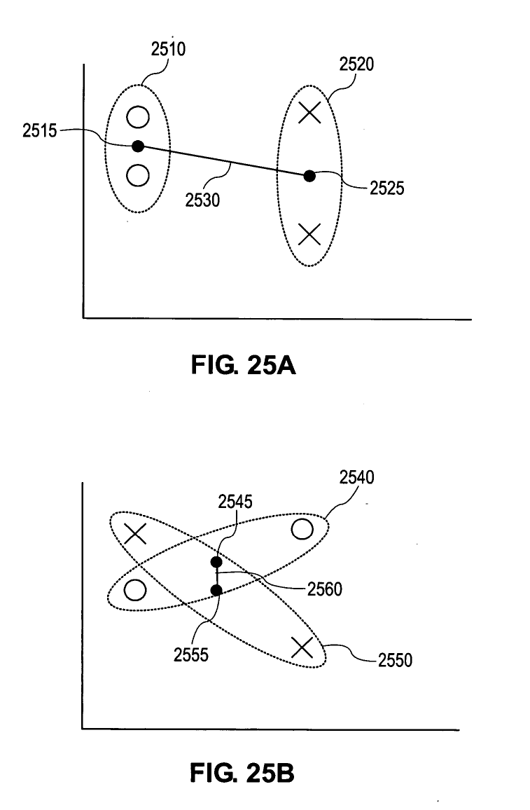

An extremely simplifed example of the first general case is shown in FIGS. 25A-B. In FIG. 25A, there are two sets of points, 2510 and 2520. Set 2510 has centroid 2515, representing the mean value of the two members of the set 2510. Set 2520 has centroid 2525, representing the mean value of the two members of the set 2520. Line 2530 represents the distance between the two centroids 2515 and 2525.

After a random permutation of the data points, resulting in an exchange of two of the points as shown in FIG. 25B, there are still two sets of data points, each having the same number of members as they did prior to the permutation. However their locations have been switched around. The two sets 2540 and 2550 contain the permuted points. Set 2540 has a new centroid 2545, and set 2550 has a new centroid 2555. Line 2560 is the distance between the two new centroids 2545 and 2555. Since line 2560 is shorter than line 2530, the counter for the permutation testing algorithm is not increased. In actual practice, the data sets may involve millions of data points or more, and there may be thousands of permutations run, but the principles will be the same as with this example. The permutations will tend to cause the centroids of the permutated data to migrate closer together, and thus the counter value will remain low.

The second case arises when the two distributions are the same. In this case, the points in each distribution are likely to be close to or intermixed with the points in the other distribution. Since the points in each distribution are close or intermixed, it is likely that the distance between the two centroids will be very small. Since the initial distance is likely to be very small, when the points are randomly re-assigned between the two sets, the centroids of the new sets will likely be farther apart than the centroids of the old sets. Thus, the distance between the new centroids is likely to be greater than the distance between the old centroids. Thus, since the counter is increased when the distance between the new centroids is greater than the distance between the old centroids, this counter value will be relatively high for the case Where the distributions of the two sets of points is the same.

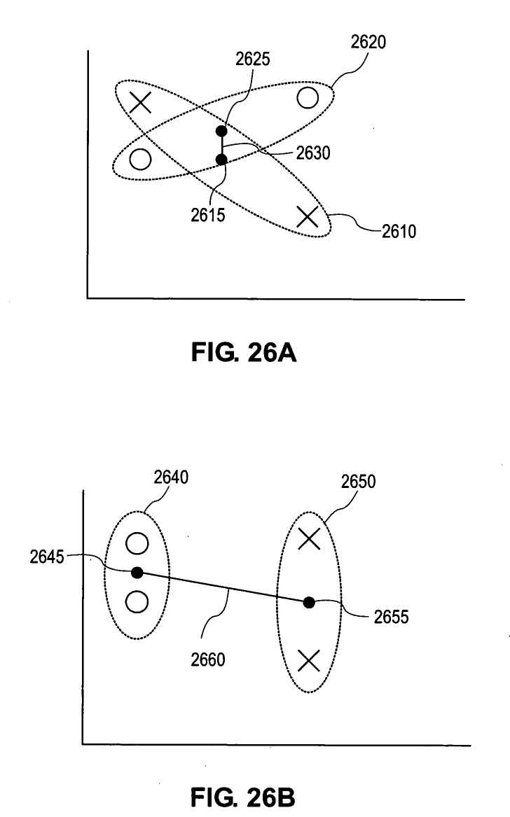

The plots of FIGS. 26A-B show an extremely simplified example of this second case. In FIG. 26A, there are two sets of points, 2610 and 2620. Set 2610 has a centroid of 2615, and set 2620 has a centroid of 2625. The line 2630 represents the distance between the two centroids 2615 and 1625.

After a random permutation of the data points, resulting in an exchange of two of the points as shown in FIG. 26B, there are still two sets of data points, each having the same number of members as they did prior to the permutation. However their locations have been switched around. The two sets 2640 and 2650 contain the permuted points. Set 2640 has a new centroid 2645, and set 2650 has a new centroid 2655. Line 2660 is the distance between the two new centroids 2645 and 2655. Since line 2660 is longer than line 2630, the counter for the permutation testing algorithm is increased by one. In actual practice, the data sets may involve millions of data points or more, and there may be thousands of permutations run, but the principles will be the same as with this example. The permutations will tend to cause the centroids of the permutated data to migrate farther apart, and thus the counter value will be increased for most of the permutation iterations, and the counter value will be relatively high.

The methods discussed above are examples of the novel methods developed to analyze financial data to identify risks of material misstatement due to fraud. In general terms, the methods of an embodiment of the invention analyze financial data according to several different approaches. For example 1) to detect unusual combinations of accounts in transactions, such as by use of account similarity trees as discussed above; 2) to detect unusual levels of activity among account clusters, such as by use of activity heat maps as discussed above; 3) to detect unusual distributions of transaction amounts, such as by use of activity distribution histograms as discussed above; 4) to detect unusual flows of money through the general ledger, such as by use of activity cluster plots as discussed above; and 5) to detect shifts in relationships among accounts over time, such as by use of relationship shift analysis, including multivariate regression analysis, as discussed above. A variable is unusual if the distribution of the variable of interest, whether combination, activity level, distributions, flows or some other variable, is significantly different in the data being studied than in some comparable control data (whether in the same company and different time periods, or other companies in the same industry, or some other suitable control data).

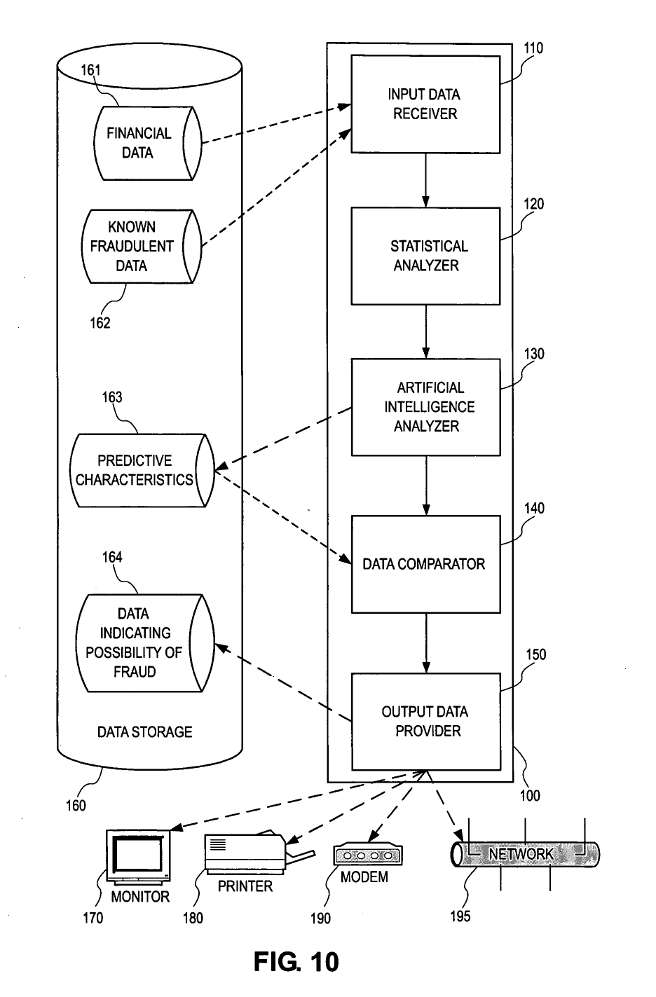

Turning to FIG. 10, a system for identifying risks of material misstatement due to fraud according to an embodiment of the invention is depicted. The system 100 is capable of performing the methods discussed above. The system 100 includes several components including an input data receiver 110, a statistical analyzer 120, an artificial intelligence analyzer 130, a data comparator 140, and an output data provider 150. The system 100 retrieves various data from a data storage device 160 and stores various data in the data storage device 160. The system 100 also provides output data to a variety of devices, such as a monitor 170, a printer 180, a modem 190 or a network 195.

The input data receiver 110 is a component that retrieves input data from the data storage 160, such as the financial data 161 or the known fraudulent data 162. The input data receiver 110 pre-preprocesses the data using methods such as those discussed above, and optionally selects a subset of the data using any of the subset selection methods discussed above, or generates an alternate set of data using methods such as the principal component analaysis discussed above to reduce the size of the input data. The input data receiver 110 passes this pre-processed data on to the statistical analyzer 120. The statistical analyzer 120 is a component that receives input data, for example from the input data receiver 110 and performs a statistical analysis on the data, for example the statistical analyses discussed above, including structural equivalence profiling, activity heat map analysis, principal component analysis, and/or multivariate regression analysis. Once the statistical analyzer 120 has analyzed the data, for example to identify anomalous data points in either the financial data 161 or the known fraudulent data 162, as discussed above, the statistical analyzer 120 forwards the results of the statistical analysis, such as the anomalous data points discussed above, on to the artificial intelligence analyzer 130 and the rest of the components of the system 100.

The artificial intelligence analyzer 130 receives data, such as the anomalous data points discussed above, from the statistical analyzer 120, and analyzes that data using an artificial intelligence technique such as the clustering algorithms, decision tree algorithms or rule induction algorithms discussed above. Once the artificial intelligence analyzer 130 has analyzed the data, for example to identify common characteristics or sets of rules for the anomalous data points identified by the statistical analyzer 120, the artificial intelligence analyzer 130 either writes the resulting data off to the data storage 160, for example as a collection of predictive characteristics (or rules) 163 drawn from the known fraudulent data 162, or it passes the resulting data, for example a collection of common characteristics of the financial data 161, on to the data comparator 140.

The data comparator 140 receives data to be compared from the artificial intelligence analyzer 130, such as the collection of common characteristics of the financial data 161. The data comparator 140 also receives from the data storage device 160 data to compare with the data to be compared, such as the collection of predictive characteristics 163 drawn from the known fraudulent data 162. After receiving these two data collections, the data comparator 140 compares the data collections, for example to identify correlations between the two data collections. These correlations between the two data collections are passed on to the output data provider 150.

The output data provider 150 receives output data from the data comparator 140, such as a list of anomalous data points which have been correlated with known fraudulent data points. The output data provider 150 provides this output data to any of a variety of output devices, such as the data storage device 160 (as data indicating a possibility of fraud 164), the monitor 170, the printer 180, the modem 190, or the network 195. These output devices are adapted to convey the output data to an auditor, such that the auditor may conduct further investigations into the data, as discussed above.

The system 100 may be composed of a set of software code modules adapted to implement the various components discussed above. Alternatively, any or all of the components may be composed of hardware devices adapted to implement the respective components discussed above, such as ASICs, FPGAs, dedicated processors, and any associated wiring or other such components. Alternatively, any combination of hardware, software and/or firmware modules may be used to implement the various components discussed above. The components of the system 100 may be contained within a single hardware device, such as a computer, or the components may be distributed amongst a number of hardware devices, such as a distributed computing system, as desired by a designer of the system 100.

The data storage device 160 may be a single storage device such as a RAM, disk drive, CD-ROM, DVD, etc., or a collection of storage devices such as a NAS, SAN, or RAID array. The data 161-164 may also be stored on different storage devices, as desired by a user of the system 100, such as an auditor. For example, the financial data 161 could be stored on a data storage device located at a business entity's site, while the components of the system 100 are located at an auditor's site. The financial data 161 would then be accessed by the system 100 using, for example, a network connection such as the Internet. Alternatively, the system 100 could be implemented in software on an auditor's personal computer, such as a laptop computer. The laptop computer would contain the system 100, and a data storage device 160 holding the fraud predictive characteristics 163, and optionally the known fraudulent data 162. The auditor would then travel to the business entity's site and connect to the business entity's computer, and financial data 161. Alternatively, the financial data 161 could be downloaded onto a storage medium such as a disk drive, DVD-ROM, etc., and transported to the site where the system 100 is located, for use by the auditor. The auditor would process that data as discussed above to generate the data indicating a possibility of fraud 164, which would be stored either on the business entity's computer or on the auditor's computer.

In the foregoing specification, the invention has been described with reference to specific embodiments thereof. It will, however, be evident that various modifications and changes may be made thereto without departing from the broader spirit and scope of the invention. For example, as has been referenced previously, in the context of specialized forensic investigation and accounting engagements, the methods and systems described herein may also be used to investigate and detect financial fraud. Similarly, the methods and systems of the present invention could be used to analyze financial data for the presence of other phenomena.

The data from business entities where fraud was known to have occurred can be analyzed to identify characteristics that are predictive of actual fraud, in addition to the analysis discussed in detail with respect to various embodiments, which identifies characteristics that are predictive of the presence of risks of material misstatement due to fraud. Therefore, by comparing these fraud predictive characteristics with the anomalous data from the business entity, the presence of actual fraud could be predicted.

For an additional example, financial data from several different entities could be analyzed to detect the presence of money laundering, by comparing the accounts of two or more business entities where money laundering transactions are suspected, with the accounts of business entities known to have participated in money laundering. For example, by processing the financial data through the statistical analysis to identify relationships among the accounts of the two or more business entities and find anomalous data that does not conform to the expected relationships, processing the anomalies through clustering algorithms to identify common characteristics of the anomalies, and then comparing the common characteristics with characteristics known to identify the presence of money laundering.

Other phenomena such as highly taxed, or less taxed companies, unusual amounts of inter-country transfers, or the presence of third-party transactions (off-balance sheet transactions) can also be detected. The specification and drawings are, accordingly, to be regarded in an illustrative rather than restrictive sense, and the invention is not to be restricted or limited except in accordance with the following claims and their legal equivalents.

1. A method of analyzing financial information, comprising:
receiving a plurality of financial data aggregations;
receiving a plurality of transactions amongst the plurality of financial data aggregations;
generating a money flow representation of a flow of money amongst the plurality of financial data aggregations, according to the plurality of transactions; and
analyzing the money flow representation using a structural equivalence profiling.

2. The method of claim 1, wherein the plurality of transactions falls within a time window.

3. The method of claim 1, wherein the financial data aggregations comprise accounts.

4. The method of claim 1, wherein the financial data aggregations comprise financial statement line items.

5. The method of claim 1, wherein the transactions comprise journal entries.

6. The method of claim 1, wherein the money flow representation comprises a graph comprising a plurality of nodes and a plurality of edges, each of the plurality of nodes comprising one of the plurality of financial data aggregations and each of the plurality of edges comprising a link between two of the plurality of nodes, the link linking two of the plurality of nodes according to one or more of the plurality of transactions.

7. The method of claim 6, wherein the analyzing step identifies a degree of similarity between a first node and a second node of the plurality of nodes.

8. The method of claim 7, wherein the similarity is determined based on a comparison of a plurality of first links between the first node and the plurality of nodes with a plurality of second links between the second node and the plurality of nodes.

9. The method of claim 8, wherein one of the plurality of first links is identified as similar to one of the plurality of second links when the one of the plurality of first links links the first node to a third node of the plurality of nodes, and the one of the plurality of second links links the second node to the third node of the plurality of nodes.

10. The method of claim 6, wherein the link represents a flow of money between the two linked nodes.

11. The method of claim 6, wherein the link is made when the financial data aggregations corresponding to the two of the plurality of nodes appear together in one of the plurality of transactions.

12. The method of claim 6, wherein the link is made when the financial data aggregations corresponding to the two of the plurality of nodes appear in consecutive transactions in the plurality of received transactions.

13. The method of claim 6, wherein the link is made when the financial data aggregations corresponding to the two of the plurality of nodes appear in two of the plurality of transactions which both occurred within a particular time period.

14. The method of claim 6, wherein one of the plurality of edges further comprises a weight.

15. The method of claim 14, wherein the weight comprises a count of the plurality of transactions that the link is based on.

16. The method of claim 14, wherein the weight comprises a total value of the plurality of transactions that the link is based on.

17. The method of claim 14, wherein the weight comprises an average value of the plurality of transactions that the link is based on.

18. The method of claim 1, wherein the money flow representation comprises a matrix of the received plurality of transactions amongst the received plurality of financial data aggregations, wherein the matrix comprises a plurality of rows, a plurality of columns, a first axis having a plurality of debited financial data aggregations, a second axis having a plurality of credited financial data aggregations, and a plurality of intersections between the plurality of rows and the plurality of columns, each intersection comprising information about one or more of the plurality of transactions between a first financial data aggregation on a row and a second financial data aggregation on a column, the column intersecting with the row.

19. The method of claim 18, wherein the information comprises a binary indication of the presence of the one or more of the plurality of transactions.

20. The method of claim 18, wherein the information comprises a total value of the one or more of the plurality of transactions.

21. The method of claim 18, wherein the information comprises an average value of the one or more of the plurality of transactions.

22. The method of claim 18, wherein the information comprises a quantity of the one or more of the plurality of transactions.

23. The method of claim 1, wherein the one of the plurality of transactions is identified by a transaction identifier.

24. The method of claim 1, wherein the one of the plurality of transactions is identified by an estimation of the presence of a transaction from transaction data found in the plurality of transactions.

25. The method of claim 1, wherein the analyzing step identifies a group of financial data aggregations having a structural relationship with each other.

26. The method of claim 25, wherein the structural relationship comprises a similar network role.

27. The method of claim 25, wherein the structural relationship is based on the links between the financial data aggregations in the group.

28. The method of claim 1, wherein the analysis generates a financial data aggregation similarity tree.

29. The method of claim 28, wherein the financial data aggregation similarity tree comprises a branch, and the account similarity tree identifies an unusual grouping of financial data aggregations on the branch.

30. The method of claim 28, further comprising comparing the identified grouping of financial data aggregations with predictive data, and determining a likelihood of material misstatement due to financial accounting fraud based on the results of the comparison.

31. The method of claim 1, further comprising selecting a subset of the plurality of financial data aggregations for further analysis, based on the results of the structural equivalence profiling analysis.

32. The method of claim 31, wherein the further analysis comprises:
identifying a plurality of anomalous data points within the plurality of transactions,
identifying a common characteristic associated with the anomalous data points,
receiving a predictive characteristic,
comparing the common characteristic with the predictive characteristic, and
determining a risk of material misstatement due to fraud based on the results of the comparison.

33. The method of claim 32, wherein identifying a plurality of anomalous data points comprises comparing for each data point the data point value with a predicted data point value, and selecting as the plurality of anomalous data points those data points whose data point values differ from the predicted data point values by a greater amount than the non-selected data point values differ from the predicted data point values.

34. The method of claim 32, wherein identifying a plurality of anomalous data points comprises using a statistical analysis to identify the plurality of anomalous data points.

35. The method of claim 34, wherein the statistical analysis comprises a time series analysis.

36. The method of claim 35, wherein the time-series analysis comprises a multivariate linear regression.

37. The method of claim 35, wherein the time series comprises a collection of time series data for a time window, based on general ledger activity and journal entries corresponding to the general ledger activity, for the time window.

38. The method of claim 32, wherein identifying a common characteristic comprises using an artificial intelligence analysis to identify the common characteristic.

39. The method of claim 38, wherein the artificial intelligence analysis comprises a clustering algorithm based analysis.

40. The method of claim 39, wherein the data points comprise general ledger activity and the clustering algorithm based analysis comprises:
finding corresponding journal entries for anomalous general ledger activity, and
using a clustering algorithm to identify a common characteristic of the journal entries underlying the anomalous general ledger activity.

41. The method of claim 38, wherein the artificial intelligence analysis comprises a decision tree algorithm based analysis.

42. The method of claim 41, wherein the data points comprise general ledger activity and the decision tree algorithm based analysis comprises:
finding corresponding journal entries for anomalous general ledger activity, and
using a decision tree algorithm to identify a common characteristic of two or more of the journal entries underlying the anomalous general ledger activity.

43. The method of claim 42, wherein the common characteristic is identified by inducing a rule that describes two or more of the journal entries underlying the anomalous general ledger activity.

44. The method of claim 32, wherein the predictive characteristic is derived from a second plurality of data points, the second plurality of data points coming from an entity where fraud has occurred.

45. The method of claim 44, wherein the predictive characteristic is derived by applying the 1) receiving a plurality of data points, 2) identifying a plurality of anomalous data points and 3) identifying a common characteristic steps to the second plurality of data points coming from an entity where fraud has occurred.

46. The method of claim 45, wherein determining a risk of material misstatement due to fraud comprises assigning a relative weight to the common characteristic based on a degree of similarity between the common characteristic and the predictive characteristic.

47. The method of claim 45, wherein determining a risk of material misstatement due to fraud comprises assigning a probability estimate of material misstatement to the common characteristic.

48. The method of claim 45, wherein determining a risk of material misstatement due to fraud comprises matching the common characteristic to the predictive characteristic wherein the predictive characteristic comprises a node in a Bayesian network containing a fraud scheme hypothesis.

49. The method of claim 1, wherein the analysis is used to make a business decision.

50. A method of identifying risks of material misstatement due to financial reporting fraud, comprising:
receiving a plurality of financial data aggregations;
receiving a plurality of transactions amongst the plurality of financial data aggregations;
generating a matrix comprising a plurality of datapoints, each datapoint representing a transaction between a pair of the plurality of financial data aggregations; and
performing a cross-association restructuring of the matrix to create a plurality of clusters of financial data aggregations.

51. The method of claim 50, wherein the clusters group the plurality of financial data aggregations according to a measure of similarity of a plurality of interactions among the plurality of financial data aggregations.

52. The method of claim 50, wherein the financial data aggregations comprise accounts.

53. The method of claim 50, wherein the financial data aggregations comprise financial statement line items.

54. The method of claim 50, wherein the transactions comprise journal entries.

55. The method of claim 50, wherein the matrix comprises an activity heat map.

56. The method of claim 50, wherein each datapoint includes information representing a transaction amount.

57. The method of claim 50, further comprising analyzing the restructured matrix using a permutation testing analysis.

58. The method of claim 50, further comprising smoothing the datapoints.

59. The method of claim 58, wherein smoothing comprises taking a logarithm of the transaction amount.

60. The method of claim 50, further comprising identifying an unusual cluster of financial data aggregations in the restructured matrix.

61. The method of claim 60, further comprising comparing the identified grouping of financial data aggregations with predictive data, and determining a likelihood of material misstatement due to financial accounting fraud based on the results of the comparison.

62. The method of claim 50, further comprising generating a financial data aggregation similarity tree from the restructured matrix, and analyzing the similarity tree to identify an unusual cluster of financial data aggregations in the similarity tree.

63. The method of claim 62, further comprising comparing the identified grouping of financial data aggregations with predictive data, and determining a likelihood of material misstatement due to financial accounting fraud based on the results of the comparison.

64. The method of claim 50, further comprising selecting a subset of the plurality of financial data aggregations for further analysis, wherein the subset is selected by selecting a cluster of financial data aggregations.

65. The method of claim 64, wherein the further analysis comprises:
identifying a plurality of anomalous data points within the plurality of transactions,
identifying a common characteristic associated with the anomalous data points,
receiving a predictive characteristic,
comparing the common characteristic with the predictive characteristic, and
determining a risk of material misstatement due to fraud based on the results of the comparison.

66. A method of identifying risks of material misstatement due to financial reporting fraud, comprising:
receiving a plurality of financial data aggregations;
receiving a plurality of transactions amongst the plurality of financial data aggregations;
generating a matrix of the transactions amongst the plurality of financial data aggregations over a time period comprising a plurality of time units, the matrix comprising a plurality of rows, a plurality of columns, a first axis having the plurality of financial data aggregations and a second axis having the plurality of time units, and each intersection between a financial data aggregation and a time unit comprising a value indicating information about the transactions affecting the financial data aggregation on the time unit; and
transforming the matrix into a plurality of principal components, using a principal component analysis of the matrix.

67. The method of claim 66, wherein the financial data aggregations comprise accounts.

68. The method of claim 66, wherein the financial data aggregations comprise financial statement line items.

69. The method of claim 66, wherein the transactions comprise journal transactions.

70. The method of claim 66, wherein the time units comprise days.

71. The method of claim 66, wherein the information about the transactions affecting the financial data aggregations on the time unit comprises a sum of amounts of the transactions.

72. The method of claim 66, wherein the information about the transactions affecting the financial data aggregations on the time unit comprises an average of amounts of the transactions.

73. The method of claim 66, wherein the information about the transactions affecting the financial data aggregations on the time unit comprises a quantity of the transactions.

74. The method of claim 66, further comprising pre-processing the matrix prior to transforming the matrix.

75. The method of claim 74, wherein the pre-processing comprises smoothing a value.

76. The method of claim 75, wherein the smoothing comprises replacing the value with an odd-numbered root of the value.

77. The method of claim 76, wherein the odd-numbered root comprises a fifth root.

78. The method of claim 74, wherein the pre-processing comprises removing a row where the values in the row are all zero.

79. The method of claim 74, wherein the pre-processing comprises removing a column where the values in the column are all zero.

80. The method of claim 74, wherein the pre-processing comprises normalizing the values identified by each of the financial data aggregations, by rescaling the values to a zero mean and a unit variance.

81. The method of claim 74, wherein the pre-processing comprises rescaling the values identified by each of the financial data aggregations to a common scale.

82. The method of claim 66, further comprising selecting a subset of the plurality of principal components for further analysis.

83. The method of claim 82, wherein the further analysis comprises:
identifying a plurality of anomalous data points within the plurality of principal components,
identifying a common characteristic associated with the anomalous data points,
receiving a predictive characteristic,
comparing the common characteristic with the predictive characteristic, and
determining a risk of material misstatement due to fraud based on the results of the comparison.

84. The method of claim 82, wherein the further processing comprises constructing a graph of the first principal component of the matrix against the second principal component of the matrix, for each row; and analyzing the graph to identify a risk of material misstatement due to fraud.

85. The method of claim 84, wherein analyzing the graph comprises identifying a cluster of datapoints within the graph.

86. The method of claim 85, wherein the cluster comprises a group of datapoints that all share a time characteristic.

87. The method of claim 86, wherein the time characteristic comprises a date at an end of a month.

88. The method of claim 86, wherein the time characteristic comprises a date at a beginning of a month.

89. The method of claim 86, wherein the time characteristic comprises a date at an end of a quarter.

90. The method of claim 86, wherein the time characteristic comprises a date at a beginning of a quarter.

91. The method of claim 86, wherein the time characteristic comprises a date at an end of a year.

92. The method of claim 86, wherein the time characteristic comprises a date at a beginning of a year.

93. The method of claim 84, wherein analyzing the graph comprises identifying an outlier within the graph.

94. The method of claim 93, wherein the outlier represents a financial data aggregation that contributes a greater than average variation in a characteristic of the plurality of financial data aggregations.

95. The method of claim 94, wherein the characteristic comprises a total balance of the plurality of financial data aggregations.

96. The method of claim 84, wherein analyzing the graph comprises performing a permutation testing analysis on the graph, to identify a first set of datapoints within the graph which are from a different data distribution than a second set of datapoints.

97. The method of claim 96, wherein the first set of datapoints comprise datapoints sharing a criterion of interest.

98. A method of identifying risks of material misstatement due to financial reporting fraud, comprising:
receiving a plurality of accounts;
receiving a plurality of transactions amongst the plurality of accounts;
analyzing the plurality of transactions and plurality of accounts to detect an unusual condition indicative of a risk of material misstatement due to financial reporting fraud; and
reporting the detected condition for further action;
wherein the analysis comprises a multivariate linear regression analysis.

99. A method of identifying risks of material misstatement due to financial reporting fraud, comprising:
receiving a plurality of accounts;
receiving a plurality of transactions amongst the plurality of accounts;
analyzing the plurality of transactions and plurality of accounts to detect an unusual condition indicative of a risk of material misstatement due to financial reporting fraud; and
reporting the detected condition for further action;
wherein the analysis comprises a structural equivalence analysis.

100. A method of identifying risks of material misstatement due to financial reporting fraud, comprising:
receiving a plurality of accounts;
receiving a plurality of transactions amongst the plurality of accounts;
analyzing the plurality of transactions and plurality of accounts to detect an unusual condition indicative of a risk of material misstatement due to financial reporting fraud; and
reporting the detected condition for further action;
wherein the analysis comprises an activity heat map analysis.

101. A method of identifying risks of material misstatement due to financial reporting fraud, comprising:
receiving a plurality of accounts;
receiving a plurality of transactions amongst the plurality of accounts;
analyzing the plurality of transactions and plurality of accounts to detect an unusual condition indicative of a risk of material misstatement due to financial reporting fraud; and
reporting the detected condition for further action;
wherein the analysis comprises a principal component analysis.

102. A method of identifying risks of material misstatement due to financial reporting fraud, comprising:
receiving a plurality of accounts;
receiving a plurality of transactions amongst the plurality of accounts;
analyzing the plurality of transactions and plurality of accounts to detect an unusual condition indicative of a risk of material misstatement due to financial reporting fraud; and
reporting the detected condition for further action;
wherein the analysis comprises a permutation testing analysis.

103. A method of identifying risks of material misstatement due to financial reporting fraud, comprising:
(a) receiving a plurality of general ledger activity values and a plurality of journal entries associated with each general ledger activity value, each journal entry having a characteristic, wherein receiving the plurality of general ledger activity values comprises selecting a subset of accounts from a general ledger, and receiving the general ledger activity values from the selected subset;
(b) performing a multivariate-regression analysis on the general ledger activity values, to identify a plurality of anomalous general ledger activity values.
(c) identifying the plurality of journal entries associated with each anomalous general ledger activity value;
(d) performing a clustering analysis on the plurality of journal entries associated with each anomalous general ledger activity value to identify a common characteristic amongst two or more of the plurality of journal entries associated with each anomalous general ledger activity value;
(e) receiving a predictive characteristic;
(f) comparing the common characteristic with the predictive characteristic to identify a correlation between the common characteristic and the predictive characteristic; and
(g) reporting the common characteristic as indicating a risk of material misstatement due to financial reporting fraud, if a correlation is identified.

104. The method of claim 103, wherein receiving a predictive characteristic comprises deriving the predictive characteristic by performing steps (a)-(d) on a second plurality of general ledger activity values and a second plurality of journal entries associated with each of the second plurality of general ledger activity values, the second pluralities of general ledger activity values and journal entries being obtained from a business entity where financial reporting fraud has previously occurred.

105. The method of claim 103, wherein selecting a subset of accounts is done by using a structural equivalence profiling analysis of a money flow graph of the accounts.

106. The method of claim 103, wherein selecting a subset of accounts is done by using an activity heat map of the accounts.

107. The method of claim 103, wherein selecting a subset of accounts is done by using a principal component analysis of the accounts.

108. A system for detecting fraud, comprising:
an input data receiver, adapted to receive financial data comprising a plurality of data points, each of the plurality of data points having a value and an associated characteristic;
a statistical analyzer, adapted to analyze the plurality of data points to identify a plurality of anomalous data points;
an artificial intelligence analyzer, adapted to identify a common characteristic associated with the anomalous data points;
a data comparator, adapted to receive a fraud predictive characteristic, compare the common characteristic with the fraud predictive characteristic, and determine a likelihood of fraud based on the results of the comparison; and
an output data provider, adapted to provide output data suggesting the presence of fraud.

109. The system of claim 108, wherein the input data receiver is adapted to pre-process the financial data.

110. The system of claim 109, wherein the pre-processing comprises selecting a subset of the financial data.

111. The system of claim 110, wherein selecting a subset of the financial data comprises performing a structural equivalence profiling on the financial data.

112. The system of claim 110, wherein selecting a subset of the financial data comprises performing an activity heat map analysis on the financial data.

113. The system of claim 110, wherein selecting a subset of the financial data comprises performing a principal component analysis on the financial data.

114. The system of claim 108, wherein the statistical analyzer is adapted to perform a principal component analysis on the plurality of data points.

115. The system of claim 108, wherein the statistical analyzer is adapted to perform a permutation testing algorithm on the plurality of data points.

116. The system of claim 108, wherein the statistical analyzer is adapted to perform a structural equivalence profiling on the plurality of data points.

117. The system of claim 108, wherein the statistical analyzer is adapted to perform an activity heat map analysis on the plurality of data points.

118. The system of claim 108, wherein the statistical analyzer is adapted to perform a multivariate regression analysis on the plurality of data points.

119. The system of claim 108, wherein the artificial intelligence analyzer is adapted to apply a clustering algorithm to the anomalous data points.

120. The system of claim 108, wherein the artificial intelligence analyzer is adapted to apply a decision tree algorithm to the anomalous data points.

121. The system of claim 108, wherein the artificial intelligence analyzer is adapted to apply a rule induction algorithm to the anomalous data points.

122. The system of claim 108, wherein the artificial intelligence analyzer is adapted to apply a permutation testing algorithm to the anomalous data points.

123. The system of claim 108, wherein the statistical analyzer, the artificial intelligence analyzer and the data comparator are adapted to iteratively process the plurality of data points.

124. The system of claim 123, wherein the iterative process is adapted to select a data point to process based at least in part on a result of a prior iteration of the iterative process.

125. The system of claim 124, wherein the result comprises a determination that fraud is likely in the data point analyzed in the prior iteration.

126. The system of claim 108, further comprising a data storage device, adapted to store one or more of the financial data and the fraud predictive characteristic.

127. The system of claim 108, wherein the system is used in connection with forensic and investigative accounting.

128. A system for identifying risks of material misstatement due to fraud, comprising:
a means for receiving input data, comprising a plurality of data points, each of the plurality of data points having a value and an associated characteristic;
a means for analyzing the input data to identify a plurality of anomalous data points;
a means for analyzing the plurality of anomalous data points to identify a common characteristic associated with the anomalous data points;
a means for receiving a predictive characteristic,
a means for comparing the common characteristic with the predictive characteristic;
a means for determining a likelihood of risks of material misstatement due to fraud based on the results of the comparison; and
a means for providing output data suggesting a risk of material misstatement due to fraud, based on the determination of the likelihood of risks of material misstatement due to fraud.

129. The system of claim 128, wherein the means for receiving input data comprises a means for selecting a subset of the input data.

130. The system of claim 128, wherein the means for analyzing the input data comprises a means for conducting a statistical analysis on the input data.

131. The system of claim 128, wherein the means for analyzing the plurality of anomalous data points comprises a means for conducting an artificial intelligence analysis on the input data.

132. The system of claim 131, wherein the artificial intelligence analysis comprises a clustering algorithm based analysis.

133. The system of claim 128, wherein the artificial intelligence analysis comprise a decision tree algorithm based analysis.
